(19) United States
(12) Patent Application Publication
(10) Pub. No.: US 2020/0056050 A1
(43) Pub. Date: Feb. 20, 2020

(54) COMPOSITIONS CONTAINING CONDUCTIVE ADDITIVES, RELATED ELECTRODES AND RELATED BATTERIES

(71) Applicant: Cabot Corporation, Boston, MA (US)

(72) Inventors: Paolina Atanassova, Billerica, MA (US); Aurelien DuPasquier, Westford, MA (US); Deanna Lanigan, Cambridge, MA (US); Miodrag Oljaca, Concord, MA (US)

(21) Appl. No.: 16/528,937

(22) Filed: Aug. 1, 2019

Related U.S. Application Data
(60) Provisional application No. 62/719,745, filed on Aug. 20, 2018.

(51) Int. Cl. C09C 1/48; C09C 1/46; H01M 4/62; H01M 10/0525

(52) U.S. Cl. CPC C09C 1/48; C09C 1/46; H01M 4/625; H01M 10/0525; C01P 2004/51; C01P 2006/40; C01P 2002/82; C01P 2002/74; C01P 2006/12

(57) ABSTRACT

A composition, includes: carbon black particles having a surface energy less than 5 mJ/m²; graphite particles having a BET surface area greater than 5 m²/g and more than about 50 graphitic layers, wherein the ratio of the carbon black particles to the graphite particles ranges from 0.25:1 to 4:1 by weight; and a liquid medium.

### FIELD OF THE INVENTION

The invention relates to compositions containing conductive additives, related electrodes, and related batteries.

### BACKGROUND

Lithium-ion batteries are commonly used sources of electrical energy for a variety of applications, such as electronic devices and electric vehicles. A lithium-ion battery typically includes a negative electrode (e.g., graphite) and a positive electrode (described below) that allow lithium ions and electrons to move to and from the electrodes during charging and discharging. An electrolyte solution in contact with the electrodes provides a conductive medium in which the ions can move. To prevent direct reaction between the electrodes, an ion-permeable separator is used to physically and electrically isolate the electrodes. When the battery is used as an energy source for a device, electrical contact is made to the electrodes, allowing electrons to flow through the device to provide electrical power, and lithium ions to move through the electrolyte from one electrode to the other electrode.

The positive electrode typically includes a conductive substrate supporting a mixture (e.g., applied as a paste) having at least an electroactive material, a binder, and a conductive additive. The electroactive material, such as a lithium transition metal oxide, is capable of receiving and releasing lithium ions. The binder, such as polyvinylidene fluoride, is used to provide mechanical integrity and stability to the electrode. Typically, since the electroactive material and the binder are electrically poorly conducting or insulating, the conductive additive (e.g., graphite and carbon black) is added to enhance the electrical conductivity of the electrode. The conductive additive and the binder, however, are generally not involved in electrochemical reactions that generate electrical energy, so these materials can negatively affect certain performance characteristics (e.g., capacity and energy density) of the battery since they effectively lower the amount of electroactive material that can be contained in the positive electrode.

### SUMMARY

In one aspect, the invention features compositions (e.g., slurries, pastes), electrode compositions, electrodes, batteries, and related methods having various combinations of conductive additives. As described herein, the combinations of conductive additives include low surface energy carbon black particles and graphite particles; carbon nanotubes and graphenes; carbon nanotubes and low surface energy carbon black particles; and low surface energy carbon black particles and graphenes.

Lithium iron phosphate (LiFePO₄ or LFP) is an electroactive material that is desirable for its low cost, safe usage, excellent power capability, and fast charge capability. For these reasons, LFP is very useful for certain end-use applications such as energy storage and electric buses. However, the electronic conductivity of LFP is lower than that of other electroactive materials based on nickel, cobalt or manganese. As a result, certain battery manufacturers prepare LFP with a carbon coating to provide full capacity utilization by providing to the LFP particles short range particle-to-particle conductivity. Some of these battery manufacturers also prepare LFP electrode compositions with additional conductive additives to improve battery power capability and cycle life. A conductive additive of particular interest is carbon nanotubes, which provide long range particle-to-current collector conductivity, which complements the short-range particle-to-particle conductivity. And even though very small amounts of carbon nanotubes are theoretically necessary to achieve electrical percolation, the low dispersability of the carbon nanotubes requires excess (i.e., more than the theoretical amount) carbon nanotubes to be used. Using excessive amounts of carbon nanotubes increases production costs, introduces impurities (e.g., iron and cobalt catalysts used to produce the carbon nanotubes), and can reduce battery capacity by reducing battery volume available for the LFP.

Applicant has discovered that the combinations of conductive additives described herein are capable of being used to reduce or to replace the use of carbon nanotubes. The combinations of conductive additives can (1) reduce the concentration of carbon nanotubes used or eliminate the use of carbon nanotubes altogether, and/or (2) reduce the total concentration of conductive additives used, while still providing excellent battery performance or improving battery performance, e.g., cycle life, cold capacity, and hot storage capacity retention. In some cases, the combinations of conductive additives are more cost effective than using only carbon nanotubes.

In another aspect, the invention features a composition, including: carbon black particles having a surface energy less than 5 mJ/m²; graphite particles having a BET surface area greater than 5 m²/g and more than about 50 graphitic layers, wherein the ratio of the carbon black particles to the graphite particles ranges from 0.25:1 to 4:1 by weight; and a liquid medium.

Embodiments of one or more aspects may include one or more of the following features. The composition includes a total of from 0.1 to 5 wt % of the carbon black particles and the graphite particles.

The carbon black particles have one, two, three, four, five, six, seven or eight of the following properties, in any combination: an Lₐ crystallite size, as determined by Raman spectroscopy, greater than 50 Å; an L_{c} crystallite size, as determined by X-ray diffraction, greater than 50 Å; % crystallinity ((I_{G}/(I_{G}+I_{D}))×100%), as determined by Raman spectroscopy, greater than 35%; a BET surface area greater than 50 m²/g; an STSA greater than 50 m²/g; an OAN greater than 100 mL/100 g; an aggregate size distribution, as indicated by D₅₀ values of particle size distributions, greater than 20 nm; and/or an oxygen content from 0 to 0.1 wt %. The carbon black particles have one, two, three, four, five, six, seven or eight of the following properties, in any combination: an Lₐ crystallite size, as determined by Raman spectroscopy, less than 100 Å; an L_{c} crystallite size, as determined by X-ray diffraction, less than 100 Å; % crystallinity ((I_{G}/(I_{G}+I_{D}))×100%), as determined by Raman spectroscopy, less than 70%; a BET surface area less than 250 m²/g; an STSA less than 250 m²/g; an OAN less than 300 mL/100 g; an aggregate size distribution, as indicated by D₅₀ values of particle size distributions, less than 400 nm; and/or an oxygen content from 0 to 0.1 wt %. The carbon black particles have one, two, three, four, five, six, seven or eight of the following properties, in any combination: an Lₐ crystallite size, as determined by Raman spectroscopy, ranging from 50 Å to 100 Å; an L_{c} crystallite size, as determined by X-ray diffraction, ranging from 50 Å to 100 Å; a % crystallinity ((I_{G}/(I_{G}+I_{D}))×100%), as determined by Raman spectroscopy, ranging from 35% to 70%; a BET surface area ranging from 50 to 250 m²/g; an STSA ranging from 50 to 250 m²/g; an OAN ranging from 100 to 300 mL/100 g; an aggregate size distribution, as indicated by D₅₀ values of particle size distributions, ranging from 20 to 400 nm; and/or oxygen content from 0 to 0.1 wt %.

The graphite particles have one or both of the following properties: a diameter, as determined by laser scattering, greater than 5 micrometers; and/or a % crystallinity, ((I_{G}/(I_{G}+I_{D}))×100%), as determined by Raman spectroscopy, greater than 90%. The graphite particles have one or both of the following properties: a diameter, as determined by laser scattering, less than 25 micrometers; and/or a % crystallinity, ((I_{G}/(I_{G}+I_{D}))×100%), as determined by Raman spectroscopy, less than 100%. The graphite particles have one or both of the following properties: a diameter, as determined by laser scattering, ranging from 5 to 25 micrometers; and/or a % crystallinity, ((I_{G}/(I_{G}+I_{D}))×100%), as determined by Raman spectroscopy, ranging from 90 to 100%.

The liquid medium is selected from the group consisting of N-methylpyrrolidone (NMP), acetone, an alcohol, and water. The composition further includes a dispersant.

In another aspect, the invention features an electrode, including: an electrode composition including carbon black particles having a surface energy less than 5 mJ/m²; graphite particles having a BET surface area greater than 5 m²/g and more than about 50 graphitic layers, and lithium metal phosphate (e.g., LiMPO₄, where M=Fe, Co, Mn, and/or Ni), wherein the total concentration of the carbon black particles and the graphite particles is equal to or less than 3 wt % of the electrode composition; and a current collector contacting the electrode composition.

Embodiments of one or more aspects may include one or more of the following features. The total concentration of the carbon black particles and the graphite particles ranges from 0.5 to 3 wt % of the electrode composition. The electrode composition includes 0.1 to 2.25 wt % of the carbon black particles. The electrode composition includes 0.1 to 2.25 wt % of the graphite particles. The ratio of the carbon black particles to the graphite particles ranges from 0.25:1 to 4:1 by weight. The electrode is substantially free of carbon nanotubes. The electrode includes from 90 to 99 wt % of the lithium metal phosphate (e.g., LiMPO₄, where M=Fe, Co, Mn, and/or Ni).

The carbon black particles have one, two, three, four, five, six, seven or eight of the following properties, in any combination: an Lₐ crystallite size, as determined by Raman spectroscopy, greater than 50 Å; an L_{c} crystallite size, as determined by X-ray diffraction, greater than 50 Å; % crystallinity ((I_{G}/(I_{G}+I_{D}))×100%), as determined by Raman spectroscopy, greater than 35%; a BET surface area greater than 50 m²/g; an STSA greater than 50 m²/g; an OAN greater than 100 mL/100 g; an aggregate size distribution, as indicated by D₅₀ values of particle size distributions, greater than 20 nm; and/or an oxygen content from 0 to 0.1 wt %. The carbon black particles have one, two, three, four, five, six, seven or eight of the following properties, in any combination: an Lₐ crystallite size, as determined by Raman spectroscopy, less than 100 Å; an L_{c} crystallite size, as determined by X-ray diffraction, less than 100 Å; % crystallinity ((I_{G}/(I_{G}+I_{D}))×100%), as determined by Raman spectroscopy, less than 70%; a BET surface area less than 250 m²/g; an STSA less than 250 m²/g; an OAN less than 300 mL/100 g; an aggregate size distribution, as indicated by D₅₀ values of particle size distributions, less than 400 nm; and/or an oxygen content from 0 to 0.1 wt %. The carbon black particles have one, two, three, four, five, six, seven or eight of the following properties, in any combination: an Lₐ crystallite size, as determined by Raman spectroscopy, ranging from 50 Å to 100 Å; an L_{c} crystallite size, as determined by X-ray diffraction, ranging from 50 Å to 100 Å; a % crystallinity ((I_{G}/(I_{G}+I_{D}))×100%), as determined by Raman spectroscopy, ranging from 35% to 70%; a BET surface area ranging from 50 to 250 m²/g; an STSA ranging from 50 to 250 m²/g; an OAN ranging from 100 to 300 mL/100 g; an aggregate size distribution, as indicated by D₅₀ values of particle size distributions, ranging from 20 to 400 nm; and/or oxygen content from 0 to 0.1 wt %.

The graphite particles have one or both of the following properties: a diameter, as determined by laser scattering, greater than 5 micrometers; and/or a % crystallinity, ((I_{G}/(I_{G}+I_{D}))×100%), as determined by Raman spectroscopy, greater than 90%. The graphite particles have one or both of the following properties: a diameter, as determined by laser scattering, less than 25 micrometers; and/or a % crystallinity, ((I_{G}/(I_{G}+I_{D}))×100%), as determined by Raman spectroscopy, less than 100%. The graphite particles have one or both of the following properties: a diameter, as determined by laser scattering, ranging from 5 to 25 micrometers; and/or a % crystallinity, ((I_{G}/(I_{G}+I_{D}))×100%), as determined by Raman spectroscopy, ranging from 90 to 100%.

In another aspect, the invention features a battery including an electrode described herein.

In another aspect, the invention features a method including: using the compositions described herein make an electrode or a battery. The method can include combining lithium metal phosphate (e.g., LiMPO₄, where M=Fe, Co, Mn, and/or Ni) with the composition described herein.

In another aspect, the invention features a composition, including: carbon nanotubes; graphenes, wherein the ratio of the carbon nanotubes to the graphenes ranges from 0.25:1 to 4:1 by weight; and a liquid medium.

Embodiments of one or more aspects may include one or more of the following features. The composition includes a total of from 1 to 5 wt % of the carbon nanotubes and the graphenes.

The carbon nanotubes have one or both of the following properties: a diameter greater than 4 nm; and/or a length greater than 10 micrometers. The carbon nanotubes have one or both of the following properties: a diameter less than 40 nm; and/or a length less than 200 micrometers. The carbon nanotubes have one or both of the following properties: a diameter ranging from 4 to 40 nm; and/or a length ranging from 10 to 200 micrometers.

The graphenes have one or both of the following properties: a BET surface area greater than 100 m²/g; and/or more than or equal to about 20 graphitic layers. The graphenes have one or both of the following properties: a BET surface area less than 500 m²/g; and/or less than or equal to about 50 graphitic layers. The graphenes have one or both of the following properties: a BET surface area ranging from 100 to 500 m²/g; and/or from about 20 to about 50 graphitic layers.

The liquid medium is selected from the group consisting of N-methylpyrrolidone (NMP), acetone, an alcohol, and water. The composition further includes a dispersant.

In another aspect, the invention features an electrode, including: an electrode composition including carbon nanotubes; graphenes, wherein the ratio of the carbon nanotubes to the graphenes ranges from 0.25:1 to 4:1 by weight; and lithium metal phosphate (e.g., LiMPO₄, where M=Fe, Co, Mn, and/or Ni), wherein the total concentration of the carbon nanotubes and the graphenes is equal to or less than 3 wt % of the electrode composition; and a current collector contacting the electrode composition.

Embodiments of one or more aspects may include one or more of the following features. The total concentration of the carbon nanotubes and the graphenes ranges from 0.5 to 3 wt % of the electrode composition. The electrode composition includes 0.25 to 1 wt % of the carbon nanotubes. The electrode composition includes 0.25 to 1 wt % of the graphenes. The ratio of the carbon nanotubes to the graphenes ranges from 0.25:1 to 4:1 by weight. The electrode includes from 90 to 99 wt % of the lithium metal phosphate.

The carbon nanotubes have one or both of the following properties: a diameter greater than 4 nm; and/or a length greater than 10 micrometers. The carbon nanotubes have one or both of the following properties: a diameter less than 40 nm; and/or a length less than 200 micrometers. The carbon nanotubes have one or both of the following properties: a diameter ranging from 4 to 40 nm; and/or a length ranging from 10 to 200 micrometers.

The graphenes have one or both of the following properties: a BET surface area greater than 100 m²/g; and/or more than or equal to about 20 graphitic layers. The graphenes have one or both of the following properties: a BET surface area less than 500 m²/g; and/or less than or equal to about 50 graphitic layers. The graphenes have one or both of the following properties: a BET surface area ranging from 100 to 500 m²/g; and/or from about 20 to about 50 graphitic layers.

In another aspect, the invention features a composition, including: carbon nanotubes; carbon black particles having a surface energy less than 5 mJ/m²; wherein the ratio of the carbon nanotubes to the carbon black particles ranges from 0.25:1 to 4:1 by weight; and a liquid medium.

Embodiments of one or more aspects may include one or more of the following features. The composition includes a total of from 1 to 5 wt % of the carbon nanotubes and the carbon black particles.

The carbon nanotubes have one or both of the following properties: a diameter greater than 4 nm; and/or a length greater than 10 micrometers. The carbon nanotubes have one or both of the following properties: a diameter less than 40 nm; and/or a length less than 200 micrometers. The carbon nanotubes have one or both of the following properties: a diameter ranging from 4 to 40 nm; and/or a length ranging from 10 to 200 micrometers.

The carbon black particles have one, two, three, four, five, six, seven or eight of the following properties, in any combination: an Lₐ crystallite size, as determined by Raman spectroscopy, greater than 50 Å; an L_{c} crystallite size, as determined by X-ray diffraction, greater than 50 Å; % crystallinity ((I_{G}/(I_{G}+I_{D}))×100%), as determined by Raman spectroscopy, greater than 35%; a BET surface area greater than 50 m²/g; an STSA greater than 50 m²/g; an OAN greater than 100 mL/100 g; an aggregate size distribution, as indicated by D₅₀ values of particle size distributions, greater than 20 nm; and/or an oxygen content from 0 to 0.1 wt %. The carbon black particles have one, two, three, four, five, six, seven or eight of the following properties, in any combination: an Lₐ crystallite size, as determined by Raman spectroscopy, less than 100 Å; an L_{c} crystallite size, as determined by X-ray diffraction, less than 100 Å; % crystallinity ((I_{G}/(I_{G}+I_{D}))×100%), as determined by Raman spectroscopy, less than 70%; a BET surface area less than 250 m²/g; an STSA less than 250 m²/g; an OAN less than 300 mL/100 g; an aggregate size distribution, as indicated by D₅₀ values of particle size distributions, less than 400 nm; and/or an oxygen content from 0 to 0.1 wt %. The carbon black particles have one, two, three, four, five, six, seven or eight of the following properties, in any combination: an Lₐ crystallite size, as determined by Raman spectroscopy, ranging from 50 Å to 100 Å; an L_{c} crystallite size, as determined by X-ray diffraction, ranging from 50 Å to 100 Å; a % crystallinity ((I_{G}/(I_{G}+I_{D}))×100%), as determined by Raman spectroscopy, ranging from 35% to 70%; a BET surface area ranging from 50 to 250 m²/g; an STSA ranging from 50 to 250 m²/g; an OAN ranging from 100 to 300 mL/100 g; an aggregate size distribution, as indicated by D₅₀ values of particle size distributions, ranging from 20 to 400 nm; and/or oxygen content from 0 to 0.1 wt %;

The liquid medium is selected from the group consisting of N-methylpyrrolidone (NMP), acetone, an alcohol, and water. The composition further includes a dispersant.

In another aspect, the invention features an electrode, including: an electrode composition including carbon nanotubes; carbon black particles having a surface energy less than 5 mJ/m², wherein the ratio of the carbon nanotubes to the graphenes ranges from 0.25:1 to 4:1 by weight; and lithium metal phosphate (e.g., LiMPO₄, where M=Fe, Co, Mn, and/or Ni), wherein the total concentration of the carbon nanotubes and the carbon black particles is equal to or less than 3 wt % of the electrode composition; and a current collector contacting the electrode composition.

Embodiments of one or more aspects may include one or more of the following features. The total concentration of the carbon nanotubes and the carbon black particles ranges from 0.5 to 3 wt % of the electrode composition. The electrode composition includes 0.25 to 1 wt % of the carbon nanotubes. The electrode composition includes 0.25 to 1 wt % of the carbon black particles. The ratio of the carbon nanotubes to the carbon black particles ranges from 0.25:1 to 4:1 by weight. The electrode includes from 90 to 99 wt % of the lithium metal phosphate.

The carbon nanotubes have one or both of the following properties: a diameter greater than 4 nm; and/or a length greater than 10 micrometers. The carbon nanotubes have one or both of the following properties: a diameter less than 40 nm; and/or a length less than 200 micrometers. The carbon nanotubes have one or both of the following properties: a diameter ranging from 4 to 40 nm; and/or a length ranging from 10 to 200 micrometers.

The carbon black particles have one, two, three, four, five, six, seven or eight of the following properties, in any combination: an Lₐ crystallite size, as determined by Raman spectroscopy, greater than 50 Å; an L_{c} crystallite size, as determined by X-ray diffraction, greater than 50 Å; % crystallinity ((I_{G}/(I_{G}+I_{D}))×100%), as determined by Raman spectroscopy, greater than 35%; a BET surface area greater than 50 m²/g; an STSA greater than 50 m²/g; an OAN greater than 100 mL/100 g; an aggregate size distribution, as indicated by D₅₀ values of particle size distributions, greater than 20 nm; and/or an oxygen content from 0 to 0.1 wt %. The carbon black particles have one, two, three, four, five, six, seven or eight of the following properties, in any combination: an Lₐ crystallite size, as determined by Raman spectroscopy, less than 100 Å; an L_{c} crystallite size, as determined by X-ray diffraction, less than 100 Å; % crystallinity ((I_{G}/(I_{G}+I_{D}))×100%), as determined by Raman spectroscopy, less than 70%; a BET surface area less than 250 m²/g; an STSA less than 250 m²/g; an OAN less than 300 mL/100 g; an aggregate size distribution, as indicated by D₅₀ values of particle size distributions, less than 400 nm; and/or an oxygen content from 0 to 0.1 wt %. The carbon black particles have one, two, three, four, five, six, seven or eight of the following properties, in any combination: an Lₐ crystallite size, as determined by Raman spectroscopy, ranging from 50 Å to 100 Å; an L_{c} crystallite size, as determined by X-ray diffraction, ranging from 50 Å to 100 Å; a % crystallinity ((I_{G}/(I_{G}+I_{D}))×100%), as determined by Raman spectroscopy, ranging from 35% to 70%; a BET surface area ranging from 50 to 250 m²/g; an STSA ranging from 50 to 250 m²/g; an OAN ranging from 100 to 300 mL/100 g; an aggregate size distribution, as indicated by D₅₀ values of particle size distributions, ranging from 20 to 400 nm; and/or oxygen content from 0 to 0.1 wt %.

In another aspect, the invention features composition, including: carbon black particles having a surface energy less than 5 mJ/m²; graphenes, wherein the ratio of the carbon black particles to the graphenes ranges from 0.25:1 to 4:1 by weight; and a liquid medium.

Embodiments of one or more aspects may include one or more of the following features. The composition includes a total of from 0.1 to 5 wt % of the carbon black particles and the graphenes.

The carbon black particles have one, two, three, four, five, six, seven or eight of the following properties, in any combination: an Lₐ crystallite size, as determined by Raman spectroscopy, greater than 50 Å; an L_{c} crystallite size, as determined by X-ray diffraction, greater than 50 Å; % crystallinity ((I_{G}/(I_{G}+I_{D}))×100%), as determined by Raman spectroscopy, greater than 35%; a BET surface area greater than 50 m²/g; an STSA greater than 50 m²/g; an OAN greater than 100 mL/100 g; an aggregate size distribution, as indicated by D₅₀ values of particle size distributions, greater than 20 nm; and/or an oxygen content from 0 to 0.1 wt %. The carbon black particles have one, two, three, four, five, six, seven or eight of the following properties, in any combination: an Lₐ crystallite size, as determined by Raman spectroscopy, less than 100 Å; an L_{c} crystallite size, as determined by X-ray diffraction, less than 100 Å; % crystallinity ((I_{G}/(I_{G}+I_{D}))×100%), as determined by Raman spectroscopy, less than 70%; a BET surface area less than 250 m²/g; an STSA less than 250 m²/g; an OAN less than 300 mL/100 g; an aggregate size distribution, as indicated by D₅₀ values of particle size distributions, less than 400 nm; and/or an oxygen content from 0 to 0.1 wt %. The carbon black particles have one, two, three, four, five, six, seven or eight of the following properties, in any combination: an Lₐ crystallite size, as determined by Raman spectroscopy, ranging from 50 Å to 100 Å; an L_{c} crystallite size, as determined by X-ray diffraction, ranging from 50 Å to 100 Å; a % crystallinity ((I_{G}/(I_{G}+I_{D}))×100%), as determined by Raman spectroscopy, ranging from 35% to 70%; a BET surface area ranging from 50 to 250 m²/g; an STSA ranging from 50 to 250 m²/g; an OAN ranging from 100 to 300 mL/100 g; an aggregate size distribution, as indicated by D₅₀ values of particle size distributions, ranging from 20 to 400 nm; and/or oxygen content from 0 to 0.1 wt %.

The graphenes have one or both of the following properties: a BET surface area greater than 100 m²/g; and/or more than or equal to about 20 graphitic layers. The graphenes have one or both of the following properties: a BET surface area less than 500 m²/g; and/or less than or equal to about 50 graphitic layers. The graphenes have one or both of the following properties: a BET surface area ranging from 100 to 500 m²/g; and/or from about 20 to about 50 graphitic layers.

The liquid medium is selected from the group consisting of N-methylpyrrolidone (NMP), acetone, an alcohol, and water. The composition further includes a dispersant.

In another aspect, the invention features electrode, including: an electrode composition including carbon black particles having a surface energy less than 5 mJ/m²; graphenes, and lithium metal phosphate (e.g., LiMPO₄, where M=Fe, Co, Mn, and/or Ni), wherein the total concentration of the carbon black particles and the graphenes is equal to or less than 3 wt % of the electrode composition; and a current collector contacting the electrode composition.

Embodiments of one or more aspects may include one or more of the following features. The total concentration of the carbon black particles and the graphenes ranges from 0.5 to 3 wt % of the electrode composition. The electrode composition includes 0.1 to 2.25 wt % of the carbon black particles. The electrode composition includes 0.1 to 2.25 wt % of the graphenes. The ratio of carbon black particles to the graphenes ranges from 0.25:1 to 4:1 by weight. The electrode is substantially free of carbon nanotubes. The electrode includes from 90 to 99 wt % of the lithium metal phosphate.

The carbon black particles have one, two, three, four, five, six, seven or eight of the following properties, in any combination: an Lₐ crystallite size, as determined by Raman spectroscopy, greater than 50 Å; an L_{c} crystallite size, as determined by X-ray diffraction, greater than 50 Å; % crystallinity ((I_{G}/(I_{G}+I_{D}))×100%), as determined by Raman spectroscopy, greater than 35%; a BET surface area greater than 50 m²/g; an STSA greater than 50 m²/g; an OAN greater than 100 mL/100 g; an aggregate size distribution, as indicated by D₅₀ values of particle size distributions, greater than 20 nm; and/or an oxygen content from 0 to 0.1 wt %. The carbon black particles have one, two, three, four, five, six, seven or eight of the following properties, in any combination: an Lₐ crystallite size, as determined by Raman spectroscopy, less than 100 Å; an L_{c} crystallite size, as determined by X-ray diffraction, less than 100 Å; % crystallinity ((I_{G}/(I_{G}+I_{D}))×100%), as determined by Raman spectroscopy, less than 70%; a BET surface area less than 250 m²/g; an STSA less than 250 m²/g; an OAN less than 300 mL/100 g; an aggregate size distribution, as indicated by D₅₀ values of particle size distributions, less than 400 nm; and/or an oxygen content from 0 to 0.1 wt %. The carbon black particles have one, two, three, four, five, six, seven or eight of the following properties, in any combination: an Lₐ crystallite size, as determined by Raman spectroscopy, ranging from 50 Å to 100 Å; an L_{c} crystallite size, as determined by X-ray diffraction, ranging from 50 Å to 100 Å; a % crystallinity ((I_{G}/(I_{G}+I_{D}))×100%), as determined by Raman spectroscopy, ranging from 35% to 70%; a BET surface area ranging from 50 to 250 m²/g; an STSA ranging from 50 to 250 m²/g; an OAN ranging from 100 to 300 mL/100 g; an aggregate size distribution, as indicated by D₅₀ values of particle size distributions, ranging from 20 to 400 nm; and/or oxygen content from 0 to 0.1 wt %.

The graphenes have one or both of the following properties: a BET surface area greater than 100 m²/g; and/or more than or equal to about 20 graphitic layers. The graphenes have one or both of the following properties: a BET surface area less than 500 m²/g; and/or less than or equal to about 50 graphitic layers. The graphenes have one or both of the following properties: a BET surface area ranging from 100 to 500 m²/g; and/or from about 20 to about 50 graphitic layers.

Unless expressly indicated otherwise, all percentages herein are weight percentages.

Other aspects, features, and advantages of the invention will be apparent from the description of the embodiments thereof and from the claims.

### BRIEF DESCRIPTION OF THE DRAWINGS

FIG. 1 is a plot showing four-probe sheet resistance measurements of LiFePO₄ (LFP) electrodes coated on Mylar® films using conductive additives disclosed herein.

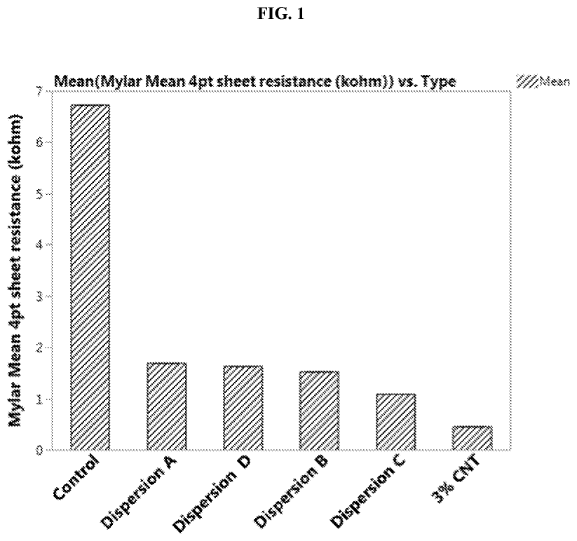

FIG. 2 is a plot showing 5C discharge capacity and HPPC DC-IR at 20% state of charge (SOC) of half coin-cells having LFP cathodes using conductive additives disclosed herein.

FIG. 3 is a plot showing 1C discharge capacity retention at −20° C. relative to 1C discharge capacity at +20° C. of half coin-cells having LFP cathodes using conductive additives disclosed herein.

FIG. 4 is a plot showing 1C, 2C and 5C discharge capacity retention after 48 h hot storage at 85° C. relative to 1C, 2C and 5C discharge capacity before hot storage of half coin-cells having LFP cathodes using conductive additives disclosed herein.

FIG. 5 is a plot showing the number of 1C-1D charge-discharge cycles completed at 60° C. until 80% of initial capacity retention of full coin-cells having graphite anodes and LFP cathodes using conductive additives disclosed herein.

### DETAILED DESCRIPTION OF THE EMBODIMENTS

Described herein are compositions (e.g., slurries) that can be used to produce electrodes for batteries (e.g., lithium ion batteries), methods of making the compositions, and applications of the compositions in electrodes (e.g., cathodes) and batteries.

The compositions typically include a combination of two conductive additives and a liquid medium (e.g., N-methylpyrrolidone (NMP)). The compositions can be combined with lithium metal phosphate (e.g., LiMPO₄, where M=Fe, Co, Mn, and/or Ni), with or without a binder (e.g., poly(vinyldifluoroethylene) (PVDF)), to form an electrode composition that can be applied to a current collector to form an electrode, which can be used to produce a battery. Specific combinations of two conductive additives include (1) carbon black particles as described herein and graphite particles as described herein; (2) carbon nanotubes as described herein and graphenes as described herein; (3) carbon nanotubes as described herein and carbon black particles as described herein; and (4) carbon black particles as described herein and graphenes as described herein.

Carbon Black Particles

The carbon black particles are generally highly graphitized carbon black particles, as indicated by their low surface energies, among other things. In addition, the carbon black particles can have one or more (e.g., two, three, four, five, six, seven, or eight) of the following properties: an Lₐ crystallite size as described herein; an L_{c} crystallite size as described herein; a % crystallinity as described herein; a Brunauer-Emmett-Teller (BET) as described herein; a statistical thickness surface area (STSA) as described herein; an oil adsorption number (OAN) as described herein; an aggregate size distribution as described herein; and/or an oxygen content as described herein.

As indicated above, the carbon black particles have a high degree of graphitization, which can be indicated by lower surface energy values that can be associated with lower amounts of residual impurities on the surface of carbon black particles, and thus, their hydrophobicity. Without being bound by theory, it is believed that, up to a threshold purity level, purer particles can provide improved electrical conductivity and reduced likelihood of side reactions, thereby improving the performance of the particles. Surface energy can be measured by Dynamic Vapor (Water) Sorption (DVS) or water spreading pressure (described below). In some embodiments, the carbon black particles have a surface energy (SE or SEP) less than or equal to 5 mJ/m², e.g., from the detection limit (about 2 mJ/m²) to 5 mJ/m². The surface energy can have or include, for example, one of the following ranges: from the detection limit to 4 mJ/m², or from the detection limit to 3 mJ/m². In certain embodiments, the surface energy, as measured by DWS, is less than or equal to 4 mJ/m², or less than or equal to 3 mJ/m². Other ranges within these ranges are possible.

Water spreading pressure is a measure of the interaction energy between the surface of carbon black (which absorbs no water) and water vapor. The spreading pressure is measured by observing the mass increase of a sample as it adsorbs water from a controlled atmosphere. In the test, the relative humidity (RH) of the atmosphere around the sample is increased from 0% (pure nitrogen) to about 100% (water-saturated nitrogen). If the sample and atmosphere are always in equilibrium, the water spreading pressure (πₑ) of the sample is defined as:

$${π}_{e} = \frac{RT}{A} {\int }_{o}^{{P}_{o}} Γ dlnP$$

where R is the gas constant, T is the temperature, A is the BET surface area of the sample as described herein, Γ is the amount of adsorbed water on the sample (converted to moles/gm), P is the partial pressure of water in the atmosphere, and Pₒ is the saturation vapor pressure in the atmosphere. In practice, the equilibrium adsorption of water on the surface is measured at one or (preferably) several discrete partial pressures and the integral is estimated by the area under the curve.

The procedure for measuring the water spreading pressure is detailed in “Dynamic Vapor Sorption Using Water, Standard Operating Procedure”, rev. Feb. 8, 2005 (incorporated in its entirety by reference herein), and is summarized here. Before analysis, 100 mg of the carbon black to be analyzed was dried in an oven at 125° C. for 30 minutes. After ensuring that the incubator in the Surface Measurement Systems DVS1 instrument (supplied by SMS Instruments, Monarch Beach, Calif.) had been stable at 25° C. for 2 hours, sample cups were loaded in both the sample and reference chambers. The target RH was set to 0% for 10 minutes to dry the cups and to establish a stable mass baseline. After discharging static and taring the balance, approximately 10-12 mg of carbon black was added to the cup in the sample chamber. After sealing the sample chamber, the sample was allowed to equilibrate at 0% RH. After equilibration, the initial mass of the sample was recorded. The relative humidity of the nitrogen atmosphere was then increased sequentially to levels of approximately 0, 5, 10, 20, 30, 40, 50, 60, 70, 80, 90, and 95% RH, with the system allowed to equilibrate for 20 minutes at each RH level. The mass of water adsorbed at each humidity level was recorded, from which water spreading pressure was calculated (see above). The measurement was done twice on two separate samples and the average value is reported.

The carbon black particles have a crystallite size that indicates a relatively high degree of graphitization. A higher degree of graphitization correlates with certain crystalline domains as shown by higher Lₐ crystallite size values, as determined by Raman spectroscopy, where Lₐ is defined as 43.5×(area of G band/area of D band). Raman measurements of Lₐ were based on Gruber et al., “Raman studies of heat-treated carbon blacks,” Carbon Vol. 32 (7), pp. 1377-1382, 1994, which is incorporated herein by reference. The Raman spectrum of carbon includes two major “resonance” bands or peaks at about 1340 cm⁻¹ and 1580 cm⁻¹, denoted as the “D” and “G” bands, respectively. It is generally considered that the D band is attributed to disordered sp² carbon, and the G band to graphitic or “ordered’ sp² carbon. Using an empirical approach, the ratio of the G/D bands and an Lₐ measured by X-ray diffraction (XRD) are highly correlated, and regression analysis gives the empirical relationship:

Lₐ=43.5×(area of G band/area of D band),

in which Lₐ is calculated in Angstroms. Thus, a higher Lₐ value corresponds to a more ordered crystalline structure.

In some embodiments, the carbon black particles have an Lₐ crystallite size of greater than or equal to 50 Å, or less than or equal to 100 Å, for example, from 50 Å to 100 Å. The Lₐ crystallite size can have or include, for example, one of the following ranges: from 50 to 90 Å, or from 50 to 80 Å, or from 50 to 70 Å, or from 50 to 60 Å, or from 60 to 100 Å, or from 60 to 90 Å, or from 60 to 80 Å, or from 60 to 70 Å, or from 70 to 100 Å, or from 70 to 90 Å, or from 70 to 80 Å, or from 80 to 100 Å, or from 80 to 90 Å, or from 90 to 100 Å. In certain embodiments, the Lₐ crystallite size is less than or equal to 90 Å, or less than or equal to 80 Å, or less than or equal to 70 Å, or less than or equal to 60. In some embodiments, the Lₐ crystallite size is greater than or equal to 60 Å, or greater than or equal to 70 Å, or greater than or equal to 80 Å, or greater than or equal to 90 Å.

The crystalline domains can be further characterized by an L_{c} crystallite size. The L_{c} crystallite size was determined by X-ray diffraction using an X-ray diffractometer (PANalytical X'Pert Pro, PANalytical B.V.), with a copper tube, tube voltage of 45 kV, and a tube current of 40 mA. A sample of carbon black particles was packed into a sample holder (an accessory of the diffractometer), and measurement was performed over angle (2θ) range of 10° to 80°, at a speed of 0.14°/min. Peak positions and full width at half maximum values were calculated by means of the software of the diffractometer. For measuring-angle calibration, lanthanum hexaboride (LaB₆) was used as an X-ray standard. From the measurements obtained, the L_{c} crystallite size was determined using the Scherrer equation: L_{c} (Å)=K*λ/(β*cos θ), where K is the shape factor constant (0.9); λ is the wavelength of the characteristic X-ray line of Cu K_{∝1} (1.54056 Å); β is the peak width at half maximum in radians; and θ is determined by taking half of the measuring angle peak position (2θ).

A higher L_{c} value corresponds to a more ordered crystalline structure. In some embodiments, the carbon black has an L_{c} crystallite size of greater than or equal 100 Å, or less than or equal to 50 Å, for example, from 50 Å to 100 Å. The L_{c} crystallite size can have or include, for example, one of the following ranges: from 50 to 90 Å, or from 50 to 80 Å, or from 50 to 70 Å, or from 50 to 60 Å, or from 60 to 100 Å, or from 60 to 90 Å, or from 60 to 80 Å, or from 60 to 70 Å, or from 70 to 100 Å, or from 70 to 90 Å, or from 70 to 80 Å, or from 80 to 100 Å, or from 80 to 90 Å, or from 90 to 100 Å. In certain embodiments, the L_{c} crystallite size is less than or equal to 90 Å, or less than or equal to 80 Å, or less than or equal to 70 Å, or less than or equal to 60. In some embodiments, the L_{c} crystallite size is greater than or equal to 60 Å, or greater than or equal to 70 Å, or greater than or equal to 80 Å, or greater than or equal to 90 Å.

The high degree of graphitization of the carbon black particles can also be indicated by a high % crystallinity, which is obtained from Raman measurements as a ratio of the area of the G band and the areas of G and D bands (I_{G}/(I_{G}+I_{D})). A high % crystallinity can be achieved by using a high heat treatment temperature and, in some embodiments, a longer heat treatment time (described below). In certain embodiments, the carbon black particles have % crystallinities ((I_{G}/(I_{G}+I_{D}))×100%) ranging from 35% to 70%, as determined by Raman spectroscopy. The % crystallinity ((I_{G}/(I_{G}+I_{D}))×100%) can have or include, for example, one of the following ranges: from 35% to 65%, or from 35% to 60%, or from 35% to 55%, or from 35% to 50%, or from 35% to 45%, or from 35% to 40%, or from 45% to 70%, or from 45% to 65%, or from 45% to 60%, or from 45% to 55%, or from 45% to 50%, or from 55% to 70%, or from 55% to 65%, or from 55% to 60%, or from 60% to 70%, or from 60% to 65%, or from 65% to 70%. The % crystallinity ((I_{G}/(I_{G}+I_{D}))×100%) can have or include, for example, one of the following ranges: greater than 35%, or greater than 40%, or greater than 45%, or greater than 50%, or greater than 55%, or greater than 60%, or greater than 65%, or less than 70%, or less than 65%, or less than 60%, or less than 55%, or less than 50%, or less than 45%, or less than 40%. Raman measurements were made using a Horiba LabRAM Aramis Raman microscope and the accompanying Lab Spec6 software.

The carbon black particles have a wide range of total surface areas. Without being bound by theory, it is believed that, during use of a battery, there are chemical side reactions that can occur within the battery that degrade its performance. Having particles with lower surface areas can enhance the performance of the battery by providing fewer surface sites where these unwanted side reactions can occur. However, the surface areas of the particles should be balanced, i.e., high enough, so that the particles can sufficiently cover and/or bridge the lithium metal phosphate and provide the desired electrode conductivity. In some embodiments, the carbon black particles have a BET surface area greater than or equal to 50 m²/g, or less than or equal to 250 m²/g, for example, ranging from 50 to 250 m²/g. The BET surface area can have or include, for example, one of the following ranges: from 50 to 225 m²/g, or from 50 to 200 m²/g, or from 50 to 175 m²/g, or from 50 to 150 m²/g, or from 50 to 125 m²/g, or from 50 to 100 m²/g, or from 50 to 75 m²/g, or from 75 to 250 m²/g, or from 75 to 225 m²/g, or from 75 to 200 m²/g, or from 75 to 175 m²/g, or from 75 to 150 m²/g, or from 75 to 125 m²/g, or from 75 to 100 m²/g, or from 100 to 250 m²/g, or from 100 to 225 m²/g, or from 100 to 200 m²/g, or from 100 to 175 m²/g, or from 100 to 150 m²/g, or from 100 to 125 m²/g, or from 125 to 250 m²/g, or from 125 to 225 m²/g, or from 125 to 200 m²/g, or from 125 to 175 m²/g, or from 125 to 150 m²/g, or 150 to 250 m²/g, or from 150 to 225 m²/g, or from 150 to 200 m²/g, or from 150 to 175 m²/g, or from 175 to 250 m²/g, or from 175 to 225 m²/g, or from 175 to 200 m²/g, or from 200 to 250 m²/g, or from 200 to 225 m²/g, or from 225 to 250 m²/g. The BET surface area can have or include, for example, one of the following ranges: greater than or equal to 75 m²/g, or greater than or equal to 100 m²/g, or greater than or equal to 125 m²/g, or greater than or equal to 150 m²/g, or greater than or equal to 175 m²/g, or greater than or equal to 200 m²/g, or greater than or equal to 225 m²/g, or less than or equal to 225 m²/g, or less than or equal to 200 m²/g, or less than or equal to 175 m²/g, or less than or equal to 150 m²/g, or less than or equal to 125 m²/g, or less than or equal to 100 m²/g, or less than or equal to 75 m²/g. Other ranges within these ranges are possible. All BET surface area values disclosed herein refer to BET nitrogen surface area and are determined by ASTM D6556-10, the entirety of which is incorporated herein by reference.

As with the BET surface areas, the carbon black particles can have a range of statistical thickness surface areas (STSAs). In some embodiments, the carbon black particles have STSAs greater than or equal to 50 m²/g, or less than or equal to 250 m²/g, for example, ranging from 50 to 250 m²/g. The STSAs can have or include, for example, one of the following ranges: from 50 to 225 m²/g, or from 50 to 200 m²/g, or from 50 to 175 m²/g, or from 50 to 150 m²/g, or from 50 to 125 m²/g, or from 50 to 100 m²/g, or from 50 to 75 m²/g, or from 75 to 250 m²/g, or from 75 to 225 m²/g, or from 75 to 200 m²/g, or from 75 to 175 m²/g, or from 75 to 150 m²/g, or from 75 to 125 m²/g, or from 75 to 100 m²/g, or from 100 to 250 m²/g, or from 100 to 225 m²/g, or from 100 to 200 m²/g, or from 100 to 175 m²/g, or from 100 to 150 m²/g, or from 100 to 125 m²/g, or from 125 to 250 m²/g, or from 125 to 225 m²/g, or from 125 to 200 m²/g, or from 125 to 175 m²/g, or from 125 to 150 m²/g, or 150 to 250 m²/g, or from 150 to 225 m²/g, or from 150 to 200 m²/g, or from 150 to 175 m²/g, or from 175 to 250 m²/g, or from 175 to 225 m²/g, or from 175 to 200 m²/g, or from 200 to 250 m²/g, or from 200 to 225 m²/g, or from 225 to 250 m²/g. The STSAs can have or include, for example, one of the following ranges: greater than or equal to 75 m²/g, or greater than or equal to 100 m²/g, or greater than or equal to 125 m²/g, or greater than or equal to 150 m²/g, or greater than or equal to 175 m²/g, or greater than or equal to 200 m²/g, or greater than or equal to 225 m²/g, or less than or equal to 225 m²/g, or less than or equal to 200 m²/g, or less than or equal to 175 m²/g, or less than or equal to 150 m²/g, or less than or equal to 125 m²/g, or less than or equal to 100 m²/g, or less than or equal to 75 m²/g. Other ranges within these ranges are possible. Statistical thickness surface area is determined by ASTM D6556-10 to the extent that such determination is reasonably possible since in some cases heat treatment of some carbon black particles (described below) can affect the ability to determine STSA.

As with the BET surface areas and STSAs, the carbon black particles can have a range of oil absorption numbers (OANs), which are indicative of the particles' structures, or volume-occupying properties. For a given mass, high structure carbon black particles can occupy more volume than other carbon black particles having lower structures. When used as a conductive additive in a battery electrode, carbon black particles having relatively high OANs can provide a continuously electrically-conductive network (i.e., percolate) throughout the electrode at relatively lower loadings. Consequently, more lithium iron phosphate or lithium iron manganate can be used, thereby improving the performance of the battery. In some embodiments, the carbon black particles have OANs greater than or equal to 100 mL/100 g, or less than or equal to 300 mL/100 g, for example, ranging from 100 to 300 mL/100 g. The OANs can have or include, for example, one of the following ranges: from 100 to 280 mL/100 g, or from 100 to 260 mL/100 g, or from 100 to 240 mL/100 g, or from 100 to 220 mL/100 g, or from 100 to 200 mL/100 g, or from 100 to 180 mL/100 g, or from 100 to 160 mL/100 g, or from 100 to 140 mL/100 g, or from 120 to 300 mL/100 g, or from 120 to 280 mL/100 g, or from 120 to 260 mL/100 g, or from 120 to 240 mL/100 g, or from 120 to 220 mL/100 g, or from 120 to 200 mL/100 g, or from 120 to 180 mL/100 g, or from 120 to 160 mL/100 g, or from 140 to 300 mL/100 g, or from 140 to 280 mL/100 g, or from 140 to 260 mL/100 g, or from 140 to 240 mL/100 g, or from 140 to 220 mL/100 g, or from 140 to 200 mL/100 g, or from 140 to 180 mL/100 g, or from 160 to 300 mL/100 g, or from 160 to 280 mL/100 g, or from 160 to 260 mL/100 g, or from 160 to 240 mL/100 g, or from 160 to 220 mL/100 g, or from 160 to 200 mL/100 g, or from 180 to 300 mL/100 g, or from 180 to 280 mL/100 g, or from 180 to 260 mL/100 g, or from 180 to 240 mL/100 g, or from 180 to 220 mL/100 g, or from 200 to 300 mL/100 g, or from 200 to 280 mL/100 g, or from 200 to 260 mL/100 g, or from 200 to 240 mL/100 g, or from 220 to 300 mL/100 g, or from 220 to 280 mL/100 g, or from 220 to 260 mL/100 g, or from 260 to 300 mL/100 g. The OAN can have or include, for example, one of the following ranges: greater than or equal to 120 mL/100 g, or greater than or equal to 140 mL/100 g, or greater than or equal to 160 mL/100 g, or greater than or equal to 180 mL/100 g, or greater than or equal to 200 mL/100 g, or greater than or equal to 220 mL/100 g, or greater than or equal to 240 mL/100 g, or greater than or equal to 260 mL/100 g, or greater than or equal to 280 mL/100 g, or less than or equal to 280 mL/100 g, or less than or equal to 260 mL/100 g, or less than or equal to 240 mL/100 g, or less than or equal to 220 mL/100 g, or less than or equal to 200 mL/100 g, or less than or equal to 180 mL/100 g, or less than or equal to 160 mL/100 g, or less than or equal to 140 mL/100 g, or less than or equal to 120 mL/100 g. Other ranges within these ranges are possible. All OAN values cited herein are determined by the method described in ASTM D 2414-16.

The aggregate size distribution of the carbon black particles, as indicated by their D50 values (also known as the “mass median diameter”) of their particle size distributions, can be greater than or equal to 20 nm, or less than or equal to 400 nm, e.g., ranging from 20 nm to 400 nm. Without being bound by theory, it is believed that, for a given structure (e.g., as indicated by an OAN) and mass, a smaller aggregate size is indicative of a higher number of particles, which can improve conductivity. It is believed that carbon black particles having the aggregate size distribution disclosed herein are capable of improving conductivity. The D₅₀ values can have or include, for example, one of the following ranges: from 20 to 350 nm, or from 20 to 300 nm, or from 20 to 250 nm, or from 20 to 200 nm, or from 20 to 150 nm, or from 20 to 100 nm, or from 50 to 400 nm, or from 50 to 350 nm, or from 50 to 300 nm, or from 50 to 250 nm, or from 50 to 200 nm, or from 50 to 150 nm, or from 100 to 400 nm, or from 100 to 350 nm, or from 100 to 300 nm, or from 100 to 250 nm, or from 100 to 200 nm, or from 150 to 400 nm, or from 150 to 350 nm, or from 150 to 300 nm, or from 150 to 250 nm, or from 200 to 400 nm, or from 200 to 350 nm, or from 200 to 300 nm, or from 250 to 400 nm, or from 250 to 350 nm, or from 300 to 400 nm. The D₅₀ values can have or include, for example, one of the following ranges: greater than or equal to 50 nm, or greater than or equal to 100 nm, or greater than or equal to 150 nm, or greater than or equal to 200 nm, or greater than or equal to 250 nm, or greater than or equal to 300 nm, or greater than or equal to 350 nm, or less than or equal to 350 nm, or less than or equal to 300 nm, or less than or equal to 250 nm, or less than or equal to 200 nm, or less than or equal to 150 nm, or less than or equal to 100 nm, or less than or equal to 50 nm. Particle size distribution measurements to determine the D-values disclosed herein were performed using a differential centrifugal sedimentation (DCS) method. The DCS method was performed using a disc centrifuge (CPS Instruments, Model DC24000) and an ultrasonic processor (Branson, Model 450D with a half-inch probe tip). Dispersion samples were prepared by sonicating compositions each containing 0.02 g carbon black and 50 mL dispersion fluid (75% v/v water, 25% v/v ethanol and 0.05% w/v Triton X100 surfactant) at an amplitude of 60% for ten minutes. Instrument settings included a particle density of 1.86; a refractive index of 1.84; an absorptivity of 0.85; and a non-sphericity of 1.0. Run conditions included a disc speed of 24K rpm; a gradient of 24 to 8% sucrose in deionized water (14.4 ml); a gradient density of 1.045; a gradient refractive index of 1.345; a gradient viscosity of 1.25 cP; and a calibration standard of 237 nm polystyrene (density 1.385).

The carbon black particles can have a relatively low oxygen content, which can be indicative of the particles' purity and electrical conductivity properties. In some embodiments, the carbon black has an oxygen content of less than or equal to 0.1 wt %, or less than or equal to 0.06 wt %%, or less than or equal to 0.03 wt %, for example, from 0 to 0.1 wt %. The oxygen content can have or include, for example, one of the following ranges: from 0.01 to 0.1 wt %, or from 0.01 to 0.06 wt %, or from 0.03 to 0.1 wt %, or from 0.03 to 0.06 wt %, or from 0.06 to 0.1 wt %. The oxygen content can be determined by inert gas fusion in which a sample of carbon black particles are exposed to very high temperatures (e.g., about 3000° C.) under inert gas conditions. The oxygen in the sample reacts with carbon to form CO and CO₂, which can be monitored by a non-dispersive infrared technique. The total oxygen content is reported in weight percent relative to the total weight of the sample. Various oxygen analyzers based on the inert gas fusion methods are known in the art and commercially available, for example a LECO® TCH600 analyzer.

In various embodiments, the carbon black particles are heat-treated carbon black particles. “Heat-treated carbon black particles” are carbon black particles that have undergone a “heat treatment,” which as used herein, generally refers to a post-treatment of base carbon black particles that had been previously formed, e.g., by a furnace black process. The heat treatment can occur under inert conditions (i.e., in an atmosphere substantially devoid of oxygen), and typically occurs in a vessel other than that in which the base carbon black particles were formed. Inert conditions include, but are not limited to, a vacuum, and an atmosphere of inert gas, such as nitrogen, argon, and the like. In some embodiments, the heat treatment of carbon black particles under inert conditions is capable of reducing the number of impurities (e.g., residual oil and salts), defects, dislocations, and/or discontinuities in carbon black crystallites and/or increasing the degree of graphitization.

The heat treatment temperatures can vary. In various embodiments, the heat treatment (e.g., under inert conditions) is performed at a temperature of at least 1000° C., or at least 1200° C., or at least 1400° C., or at least 1500° C., or at least 1700° C., or at least 2000° C. In some embodiments, the heat treatment is performed at a temperature ranging from 1000° C. to 2500° C., e.g., from 1400° C. to 1600° C. Heat treatment performed at a temperature refers to one or more temperatures ranges disclosed herein, and can involve heating at a steady temperature, or heating while ramping the temperature up or down, either stepwise and/or otherwise.

The heat treatment time periods can vary. In certain embodiments, the heat treatment is performed for at least 1 minute, e.g., at least 30 minutes, or at least 1 hour, or at least 2 hours, or at least 6 hours, or at least 24 hours, or any of these time periods up to 48 hours, at one or more of the temperature ranges disclosed herein. In some embodiments, the heat treatment is performed for a time period ranging from 15 minutes to at least 24 hours, e.g., from 15 minutes to 6 hours, or from 15 minutes to 4 hours, or from 30 minutes to 6 hours, or from 30 minutes to 4 hours.

Generally, the heat treatment is performed until one or more desired properties of the carbon black particles (e.g., surface energy) are produced. As an example, during initial periods of heat treatment, test samples of heat treated particles can be removed, and their surface energies can be measured. If the measured surface energies are not as desired, then various heat treatment process parameters (such as heat treatment temperature and/or residence time) can be adjusted until the desired surface energy is produced.

The carbon black particles can also be commercially-available particles. Examples of carbon black particles include LITX® 50, FCX™ 80, LITX® 200, LITX® 300 and LITX® HP carbon black particles available from Cabot Corporation; C-NERGY™ C45, C-NERGY™ C65 and SUPER P® products from Imerys; and Li-400, Li-250, Li-100 and Li-435 products from Denka.

Graphite Particles

Graphite particles are known in the art. Graphite particles are carbonaceous material that include many (e.g., greater than 50, or greater than 100, or greater than 200) graphitic sheets, i.e., sheets of sp²-hybridized carbon atoms bonded to each other to form a honey-comb lattice. As described below, the graphite particles can be characterized by their BET surface areas, diameters, and/or crystallinity.

The BET surface areas of the graphite particles are typically greater than 5 m²/g, or less than 50 m²/g, for example, ranging from 5 to 50 m²/g, or 10 to 25 m²/g. The BET surface area can have or include, for example, one of the following ranges: 5 to 40 m²/g, or 5 to 30 m²/g, or 5 to 20 m²/g, or 10 to 50 m²/g, or 10 to 40 m²/g, or 10 to 30 m²/g, or 20 to 50 m²/g, or 20 to 40 m²/g, or 30 to 50 m²/g. The BET surface area can have or include, for example, one of the following ranges: greater than or equal to 10 m²/g, or greater than or equal to 20 m²/g, or greater than or equal to 30 m²/g, or greater than or equal to 40 m²/g, or less than or equal to 40 m²/g, or less than or equal to 30 m²/g, or less than or equal to 20 m²/g. Other ranges within these ranges are possible.

The average diameters of the graphite particles are typically greater than or equal to 5 micrometers, or less than or equal to 25 micrometers, for example, ranging from 5 to 25 micrometers. The diameter can have or include, for example, one of the following ranges: from 5 to 20 micrometers, or from 5 to 15 micrometers, or from 5 to 10 micrometers, or from 10 to 25 micrometers, or from 10 to 20 micrometers, or from 10 to 15 micrometers, or from 15 to 25 micrometers, or from 15 to 20 micrometers, or from 20 to 25 micrometers. The diameter can have or include, for example, one of the following ranges: greater than or equal to 10 micrometers, or greater than or equal to 15 micrometers, or greater than or equal to 20 micrometers, or less than or equal to 20 micrometers, or less than or equal to 15 micrometers, or less than or equal to 10 micrometers. Other ranges within these ranges are possible. The diameter is determined in NMP solutions by laser scattering using a Microtrac Model X100 laser diffraction particle size instrument.

The crystallinity of the graphite particles is typically greater than or equal to 90%, or less than or equal to 100%, for example, ranging from 90 to 100%. The crystallinity can have or include, for example, one of the following ranges: from 90 to 98%, or from 90 to 96%, or from 90 to 94%, or from 92 to 100%, or from 92 to 98%, or from 92 to 96%, or from 94 to 100%, or from 94 to 98%, or from 96 to 100%. The crystallinity can have or include, for example, one of the following ranges: greater than or equal to 92%, or greater than or equal to 94%, or greater than or equal to 96%, or less than or equal to 98%, or less than or equal to 96%, or less than or equal to 94%. Other ranges within these ranges are possible. Crystallinity is determined from Raman measurements as a ratio of the area of the G band and the areas of G and D bands (I_{G}/(I_{G}+I_{D})).

Examples of graphite particles include SFG6 graphite from Imerys; ABG1010 graphite particles available from Superior Graphite; and SEFG 3806, SEFG 3775 and HPM850 graphite from Asbury Carbons.

Carbon Nanotubes

Carbon nanotubes are known in the art as carbonaceous material that include at least one sheet of sp²-hybridized carbon atoms bonded to each other to form a honey-comb lattice that forms a cylindrical or tubular structure. The carbon nanotubes can be single-walled carbon nanotubes or multi-walled carbon nanotubes.

The average diameters of the carbon nanotubes are typically greater than or equal to 4 nm, or less than or equal to 40 nm, for example, ranging from 4 to 40 nm. The diameter can have or include, for example, one of the following ranges: from 4 to 35 nm, or from 4 to 30 nm, or from 4 to 25 nm, or from 4 to 20 nm, or from 4 to 15 nm, or from 4 to 10 nm, or from 10 to 40 nm, or from 10 to 35 nm, or from 10 to 30 nm, or from 10 to 25 nm, or from 10 to 20 nm, or from 15 to 40 nm, or from 15 to 35 nm, or from 15 to 30 nm, or from 15 to 25 nm, or from 20 to 40 nm, or from 20 to 35 nm, or from 20 to 30 nm, or from 25 to 40 nm, or from 25 to 35 nm, or from 30 to 40 nm. The diameter can have or include, for example, one of the following ranges: greater than or equal to 10 nm, or greater than or equal to 15 nm, or greater than or equal to 20 nm, or greater than or equal to 25 nm, or greater than or equal to 30 nm, or greater than or equal to 35 nm, or less than or equal to 35 nm, or less than or equal to 30 nm, or less than or equal to 25 nm, or less than or equal to 20 nm, or less than or equal to 15 nm, or less than or equal to 10 nm. Other ranges within these ranges are possible. The diameter is determined by scanning electron microscopy (SEM), e.g., from randomly selected particles (n=100).

The average lengths of the carbon nanotubes are typically greater than or equal to 10 nm, or less than or equal to 200 nm, for example, ranging from 10 to 200 nm. The length can have or include, for example, one of the following ranges: from 10 to 150 nm, or from 10 to 100 nm, or from 10 to 50 nm, or from 50 to 200 nm, or from 50 to 150 nm, or from 50 to 100 nm, or from 100 to 200 nm, or from 100 to 150 nm, or from 150 to 200 nm. The length can have or include, for example, one of the following ranges: greater than or equal to 50 nm, or greater than or equal to 75 nm, or greater than or equal to 100 nm, or greater than or equal to 125 nm, or greater than or equal to 150 nm, or greater than or equal to 175 nm, or less than or equal to 175 nm, or less than or equal to 150 nm, or less than or equal to 125 nm, or less than or equal to 100 nm, or less than or equal to 75 nm, or less than or equal to 50 nm. Other ranges within these ranges are possible. The length is determined by scanning electron microscopy (SEM), e.g., from randomly selected particles (n=100).

Examples of carbon nanotubes are LB101 and LB107 products from Cnano Technology Ltd.; HX-N1, HX-N2 and HX-N6 products from Haoxin Technology; NTP 3003, NTP 3021, NTP 3103, and NTP 3121 products from Shenzhen Nanotech Port Co. Ltd.; and GCNTs5, HCNTs10, CNTs20 and CNTs40 products from SUSN.

Graphenes

“Graphenes” as used herein are carbonaceous material that include at least one single-atom thick sheet of sp²-hybridized carbon atoms bonded to each other to form a honey-comb lattice. Graphenes can include single layer graphenes, few layer graphenes, and/or graphene aggregates. In certain embodiments, the graphenes comprise few-layer graphenes (FLGs) having two or more stacked graphene sheets, e.g., a 2-50 layer graphenes, or 20-50 layer graphenes. In some embodiments, the graphenes include single-layer graphene and/or 2-20 layer graphenes (or other ranges disclosed herein). In other embodiments, the graphenes include 3-15 layer graphenes. The number of layers is estimated from its known relationship to BET surface area of graphene sheets.

The dimensions of graphenes are typically defined by thickness and lateral domain size. Graphene thickness generally depends on the number of layered graphene sheets. The dimension transverse to the thickness is referred to herein as the “lateral” dimension. In various embodiments, the graphenes have a lateral size ranging from 10 nm to 10 μm, e.g., from 10 nm to 5 μm, or from 10 nm to 2 μm, or from 100 nm to 10 μm, or from 100 nm to 5 μm, or from 100 nm to 2 or from 0.5 μm to 10 or from 0.5 μm to 5 or from 0.5 μm to 2 or from 1 μm to 10 or from 1 μm to 5 or from 1 μm to 2 μm.

The graphenes can exist as discrete particles and/or as aggregates. “Aggregates” refers to a plurality of graphene particles (platelets) comprising few layer graphenes that are adhered to each other. For graphene aggregates, “lateral domain size” refers to the longest indivisible dimension of the aggregate. Thickness of the aggregates is defined as the thickness of the individual graphene particle. Graphene aggregates can be generated mechanically, e.g., by exfoliation of graphite.

In some embodiment, the surface area of the graphenes is a function of the number of sheets stacked upon each other and can be calculated based on the number of layers. In certain embodiments, the graphenes have no microporosity. For example, the surface area of a graphene monolayer with no porosity is 2700 m²/g. The surface area of a two-layer graphene with no porosity can be calculated as 1350 m²/g. In other embodiments, the surface area of the graphenes results from the combination of the number of stacked sheets and amorphous cavities or pores. In various embodiments, the graphenes have a microporosity ranging from greater than 0% to 50%, e.g., from 20% to 45% or from 20% to 30%. In some embodiments, the graphenes have a BET surface area greater than or equal to 100 m²/g, or less than or equal to 500 m²/g, for example, ranging from 100 to 500 m²/g. The BET surface area can have or include, for example, one of the following ranges: from 100 to 450 m²/g, or from 100 to 400 m²/g, or from 100 to 350 m²/g, or from 100 to 300 m²/g, or from 100 to 250 m²/g, or from 100 to 200 m²/g, or from 150 to 500 m²/g, or from 150 to 450 m²/g, or from 150 to 400 m²/g, or from 150 to 350 m²/g, or from 150 to 300 m²/g, or from 150 to 250 m²/g, or from 200 to 500 m²/g, or from 200 to 450 m²/g, or from 200 to 400 m²/g, or from 200 to 350 m²/g, or from 200 to 300 m²/g, or from 250 to 500 m²/g, or from 250 to 450 m²/g, or from 250 to 400 m²/g, or from 250 to 350 m²/g, or from 300 to 500 m²/g, or from 300 to 450 m²/g, or from 300 to 400 m²/g, or from 350 to 500 m²/g, or 350 to 450 m²/g, or from 400 to 500 m²/g. The BET surface area can have or include, for example, one of the following ranges: greater than or equal to 150 m²/g, or greater than or equal to 200 m²/g, or greater than or equal to 250 m²/g, or greater than or equal to 300 m²/g, or greater than or equal to 350 m²/g, or greater than or equal to 400 m²/g, or greater than or equal to 450 m²/g, or less than or equal to 450 m²/g, or less than or equal to 400 m²/g, or less than or equal to 350 m²/g, or less than or equal to 300 m²/g, or less than or equal to 250 m²/g, or less than or equal to 200 m²/g, or less than or equal to 150 m²/g. Other ranges within these ranges are possible.

Graphenes can be produced by various methods, including exfoliation of graphite (mechanically, chemically) as well known in the art. Alternatively, graphenes can be synthesized through the reaction of organic precursors such as methane and alcohols, e.g., by gas phase, plasma processes, and other methods known in the art.

Graphenes are described, for example, in U.S. Patent Application Publication 2018-0021499, WO 2017/139115; and U.S. Provisional Patent Application No. 62/566,685. Examples of graphenes include the PAS1001 product from Super C; the LITX® 300G product from Cabot Corporation; HX-GS1 and HX-G8 products from Haoxin; GNC and GNP graphenes available from SUSN; and the xGnP® product from XGSciences.

Compositions Containing a Combination of Conductive Additives

The carbon black particles, graphite particles, carbon nanotubes and graphenes described herein can be combined with a liquid medium (e.g., a solvent) to form compositions (e.g., slurries, dispersions) that can be used to form electrodes.

For compositions containing carbon black particles and graphite particles described herein, the ratio of the carbon black particles to the graphite particles can range from 0.25:1 to 4:1, and/or the total concentration of the carbon black particles and the graphite particles in the composition can range from 0.1 to 5 wt %. The ratio of the carbon black particles to the graphite particles can have or include, for example, one of the following ranges: from 0.25:1 to 3.5:1, or from 0.25:1 to 3:1, or from 0.25:1 to 2.5:1, or from 0.25:1 to 2:1, or from 0.25:1 to 1.5:1, or from 0.25:1 to 1:1, or from 0.5:1 to 4:1, or from 0.5:1 to 3.5:1, or from 0.5:1 to 3:1, or from 0.5:1 to 2.5:1, or from 0.5:1 to 2:1, or from 0.5:1 to 1.5:1, or from 1:1 to 4:1, or from 1:1 to 4:1, or from 1:1 to 3.5:1, or from 1:1 to 3:1, or from 1:1 to 2.5:1, or from 1:1 to 2:1, or from 1.5:1 to 4:1, or from 1.5:1 to 3.5:1, or from 1.5:1 to 3:1, or from 1.5:1 to 2.5:1, or from 2:1 to 4:1, or from 2:1 to 3.5:1, or from 2:1 to 3:1, or from 2.5:1 to 4:1, or from 2.5:1 to 3.5:1, or from 3:1 to 4:1. The total concentration of the carbon black particles and the graphite particles in the composition can have or include, for example, one of the following ranges: from 0.1 to 4 wt %, or from 0.1 to 3 wt %, or from 0.1 to 2 wt %, or from 0.1 to 1 wt %, or from 1 to 5 wt %, or from 1 to 4 wt %, or from 1 to 3 wt %, or from 1 to 2 wt %, or from 2 to 5 wt %, or 2 to 4 wt %, or from 2 to 3 wt %, or from 3 to 5 wt %, or from 3 to 4 wt %, or from 4 to 5 wt %. Other ranges within these ranges are possible. In certain embodiments, these compositions (e.g., slurries and electrode compositions) are substantially free of added carbon nanotubes.

For compositions containing carbon nanotubes and graphenes described herein, the ratio of the carbon nanotubes to the graphenes can range from 0.25:1 to 4:1, and/or the total concentration of the carbon nanotubes and the graphenes in the composition can range from 0.5 to 5 wt %. The ratio of the carbon nanotubes to the graphenes can have or include, for example, one of the following ranges: from 0.25:1 to 3.5:1, or from 0.25:1 to 3:1, or from 0.25:1 to 2.5:1, or from 0.25:1 to 2:1, or from 0.25:1 to 1.5:1, or from 0.25:1 to 1:1, or from 0.5:1 to 4:1, or from 0.5:1 to 3.5:1, or from 0.5:1 to 3:1, or from 0.5:1 to 2.5:1, or from 0.5:1 to 2:1, or from 0.5:1 to 1.5:1, or from 1:1 to 4:1, or from 1:1 to 4:1, or from 1:1 to 3.5:1, or from 1:1 to 3:1, or from 1:1 to 2.5:1, or from 1:1 to 2:1, or from 1.5:1 to 4:1, or from 1.5:1 to 3.5:1, or from 1.5:1 to 3:1, or from 1.5:1 to 2.5:1, or from 2:1 to 4:1, or from 2:1 to 3.5:1, or from 2:1 to 3:1, or from 2.5:1 to 4:1, or from 2.5:1 to 3.5:1, or from 3:1 to 4:1. The total concentration of the carbon nanotubes and the graphenes in the composition can have or include, for example, one of the following ranges: from 1 to 5 wt %, or from 1 to 4 wt %, or from 1 to 3 wt %, or from 1 to 2 wt %, or from 2 to 5 wt %, or 2 to 4 wt %, or from 2 to 3 wt %, or from 3 to 5 wt %, or from 3 to 4 wt %, or from 4 to 5 wt %. Other ranges within these ranges are possible.

For compositions containing carbon nanotubes and carbon black particles described herein, the ratio of the carbon nanotubes to the carbon black particles can range from 0.25:1 to 4:1, and/or the total concentration of the carbon nanotubes and the carbon black particles in the composition can range from 0.5 to 5 wt %. The ratio of the carbon nanotubes to the carbon black particles can have or include, for example, one of the following ranges: from 0.25:1 to 3.5:1, or from 0.25:1 to 3:1, or from 0.25:1 to 2.5:1, or from 0.25:1 to 2:1, or from 0.25:1 to 1.5:1, or from 0.25:1 to 1:1, or from 0.5:1 to 4:1, or from 0.5:1 to 3.5:1, or from 0.5:1 to 3:1, or from 0.5:1 to 2.5:1, or from 0.5:1 to 2:1, or from 0.5:1 to 1.5:1, or from 1:1 to 4:1, or from 1:1 to 4:1, or from 1:1 to 3.5:1, or from 1:1 to 3:1, or from 1:1 to 2.5:1, or from 1:1 to 2:1, or from 1.5:1 to 4:1, or from 1.5:1 to 3.5:1, or from 1.5:1 to 3:1, or from 1.5:1 to 2.5:1, or from 2:1 to 4:1, or from 2:1 to 3.5:1, or from 2:1 to 3:1, or from 2.5:1 to 4:1, or from 2.5:1 to 3.5:1, or from 3:1 to 4:1. The total concentration of the carbon nanotubes and the carbon black particles in the composition can have or include, for example, one of the following ranges: from 1 to 5 wt %, or from 1 to 4 wt %, or from 1 to 3 wt %, or from 1 to 2 wt %, or from 2 to 5 wt %, or 2 to 4 wt %, or from 2 to 3 wt %, or from 3 to 5 wt %, or from 3 to 4 wt %, or from 4 to 5 wt %. Other ranges within these ranges are possible.

For compositions containing carbon black particles and graphenes described herein, the ratio of the carbon black particles to the graphenes can range from 0.25:1 to 4:1, and/or the total concentration of the carbon black particles and the graphenes in the composition can range from 0.1 to 5 wt %. The ratio of the carbon black particles to the graphenes can have or include, for example, one of the following ranges: from 0.25:1 to 3.5:1, or from 0.25:1 to 3:1, or from 0.25:1 to 2.5:1, or from 0.25:1 to 2:1, or from 0.25:1 to 1.5:1, or from 0.25:1 to 1:1, or from 0.5:1 to 4:1, or from 0.5:1 to 3.5:1, or from 0.5:1 to 3:1, or from 0.5:1 to 2.5:1, or from 0.5:1 to 2:1, or from 0.5:1 to 1.5:1, or from 1:1 to 4:1, or from 1:1 to 4:1, or from 1:1 to 3.5:1, or from 1:1 to 3:1, or from 1:1 to 2.5:1, or from 1:1 to 2:1, or from 1.5:1 to 4:1, or from 1.5:1 to 3.5:1, or from 1.5:1 to 3:1, or from 1.5:1 to 2.5:1, or from 2:1 to 4:1, or from 2:1 to 3.5:1, or from 2:1 to 3:1, or from 2.5:1 to 4:1, or from 2.5:1 to 3.5:1, or from 3:1 to 4:1. The total concentration of the carbon black particles and the graphenes in the composition can have or include, for example, one of the following ranges: from 0.1 to 4 wt %, or from 0.1 to 3 wt %, or from 0.1 to 2 wt %, or from 0.1 to 1 wt %, or from 1 to 5 wt %, or from 1 to 4 wt %, or from 1 to 3 wt %, or from 1 to 2 wt %, or from 2 to 5 wt %, or 2 to 4 wt %, or from 2 to 3 wt %, or from 3 to 5 wt %, or from 3 to 4 wt %, or from 4 to 5 wt %. Other ranges within these ranges are possible. In certain embodiments, these compositions (e.g., slurries and electrode compositions) are substantially free of added carbon nanotubes.

The liquid medium can be any liquid that is suitable for use with the constituents of the compositions described herein and capable of being used to manufacture the intended electrode. The solvent can be anhydrous, polar and/or aprotic. In some embodiments, the solvent has a high volatility so that, during manufacturing, it can be easily removed (e.g., evaporated), thereby reducing drying time and production costs. Exemplary solvents include, e.g., N-methylpyrrolidone (NMP), acetone, alcohols, and water.

Methods of making the compositions generally include combining the constituents of compositions and forming a homogenous mixture (e.g., by blending). The methods are not particularly limited to any particular order of adding the individual constituents of the compositions or any particular method of mixing. In some embodiments, the compositions further include one or more dispersants (e.g., a cellulosic dispersant), and/or one or more additives (e.g., a maleic anhydride polymer). Examples of dispersants and additives are described in U.S. Provisional Patent Application Nos. 62/680,648 and 62/685,574.

The compositions can be used in the production of a variety of energy storage devices, such as lithium-ion batteries. As an example, the compositions can be used to produce an electrode (e.g., cathode) composition for a lithium-ion battery. The electrode composition typically includes a mixture including the compositions described herein, lithium metal phosphate (e.g., LiMPO₄, where M=Fe, Co, Mn, and/or Ni), and optionally, a binder.

The concentration of lithium metal phosphate in the electrode composition can vary, depending on the particular type of energy storage device. In some embodiments, the lithium metal phosphate is present in the electrode composition in an amount of at least 90% by weight, relative to the total weight of the electrode composition, e.g., an amount ranging from 90% to 99% by weight, relative to the total weight of the electrode composition.

The concentration of the combinations of conductive additives in the electrode composition also vary. For electrode compositions containing carbon black particles and graphite particles described herein, the ratio of the carbon black particles to the graphite particles can range from 0.25:1 to 4:1, and/or the total concentration of the carbon black particles and the graphite particles in the electrode composition can range from 0.1 to 3 wt % relative to the total weight of the electrode composition. The ratio of the carbon black particles to the graphite particles can have or include, for example, one of the following ranges: from 0.25:1 to 3.5:1, or from 0.25:1 to 3:1, or from 0.25:1 to 2.5:1, or from 0.25:1 to 2:1, or from 0.25:1 to 1.5:1, or from 0.25:1 to 1:1, or from 0.5:1 to 4:1, or from 0.5:1 to 3.5:1, or from 0.5:1 to 3:1, or from 0.5:1 to 2.5:1, or from 0.5:1 to 2:1, or from 0.5:1 to 1.5:1, or from 1:1 to 4:1, or from 1:1 to 4:1, or from 1:1 to 3.5:1, or from 1:1 to 3:1, or from 1:1 to 2.5:1, or from 1:1 to 2:1, or from 1.5:1 to 4:1, or from 1.5:1 to 3.5:1, or from 1.5:1 to 3:1, or from 1.5:1 to 2.5:1, or from 2:1 to 4:1, or from 2:1 to 3.5:1, or from 2:1 to 3:1, or from 2.5:1 to 4:1, or from 2.5:1 to 3.5:1, or from 3:1 to 4:1. The total concentration of the carbon black particles and the graphite particles in the electrode composition can have or include, for example, one of the following ranges: from 0.1 to 2.5 wt %, or from 0.1 to 2 wt %, or from 0.1 to 1.5 wt %, or from 0.1 to 1 wt %, or from 0.1 to 0.5 wt %, or from 0.5 to 3 wt %, or from 0.5 to 2.5 wt %, or from 0.5 to 2 wt %, or from 0.5 to 1.5 wt %, or from 0.5 to 1 wt %, or from 1 to 3 wt %, or from 1 to 2.5 wt %, or from 1 to 2 wt %, or from 1 to 1.5 wt %, or from 1.5 to 3 wt %, or from 1.5 to 2.5 wt %, or from 1.5 to 2 wt %, or from 2 to 3 wt %, or from 2 to 2.5 wt %, or from 2.5 to 3 wt %. Each of the carbon black particles and graphite particles in the electrode composition can be present independently in the range of 0.1 to 2.25 wt % relative to the total weight of the electrode composition. Each concentration of the carbon black particles and the graphite particles in the electrode composition can independently have or include, for example, one of the following ranges: from 0.1 to 1.75 wt %, or from 0.1 to 1.25 wt %, or from 0.1 to 0.75 wt %, or from 0.5 to 2.25 wt %, or from 0.5 to 1.75 wt %, or from 0.5 to 1.25 wt %, or from 1 to 2.25 wt % or from 1 to 1.75 wt %, or from 1.5 to 2.25 wt %. Other ranges within these ranges are possible. In certain embodiments, these electrode compositions are substantially free of added carbon nanotubes.

For electrode compositions containing carbon nanotubes and graphenes described herein, the ratio of the carbon nanotubes to graphenes can range from 0.25:1 to 4:1, and/or the total concentration of the carbon nanotubes and graphenes in the electrode composition can range from 0.5 to 3 wt % relative to the total weight of the electrode composition. The ratio of the carbon nanotubes to graphenes can have or include, for example, one of the following ranges: from 0.25:1 to 3.5:1, or from 0.25:1 to 3:1, or from 0.25:1 to 2.5:1, or from 0.25:1 to 2:1, or from 0.25:1 to 1.5:1, or from 0.25:1 to 1:1, or from 0.5:1 to 4:1, or from 0.5:1 to 3.5:1, or from 0.5:1 to 3:1, or from 0.5:1 to 2.5:1, or from 0.5:1 to 2:1, or from 0.5:1 to 1.5:1, or from 1:1 to 4:1, or from 1:1 to 4:1, or from 1:1 to 3.5:1, or from 1:1 to 3:1, or from 1:1 to 2.5:1, or from 1:1 to 2:1, or from 1.5:1 to 4:1, or from 1.5:1 to 3.5:1, or from 1.5:1 to 3:1, or from 1.5:1 to 2.5:1, or from 2:1 to 4:1, or from 2:1 to 3.5:1, or from 2:1 to 3:1, or from 2.5:1 to 4:1, or from 2.5:1 to 3.5:1, or from 3:1 to 4:1. The total concentration of the carbon nanotubes and graphenes in the electrode composition can have or include, for example, one of the following ranges: from 0.5 to 2.5 wt %, or from 0.5 to 2 wt %, or from 0.5 to 1.5 wt %, or from 0.5 to 1 wt %, or from 1 to 3 wt %, or from 1 to 2.5 wt %, or from 1 to 2 wt %, or from 1 to 1.5 wt %, or from 1.5 to 3 wt %, or from 1.5 to 2.5 wt %, or from 1.5 to 2 wt %, or from 2 to 3 wt %, or from 2 to 2.5 wt %, or from 2.5 to 3 wt %. In certain embodiments, each of the carbon nanotubes and graphenes in the electrode composition can be present independently in the range of 0.25 to 1 wt % relative to the total weight of the electrode composition. Each concentration of the carbon nanotubes and graphenes in the electrode composition can independently have or include, for example, one of the following ranges: from 0.25 to 0.75 wt %, or from 0.5 to 1 wt %. Other ranges within these ranges are possible.

For electrode compositions containing carbon nanotubes and carbon black particles described herein, the ratio of the carbon nanotubes to carbon black particles can range from 0.25:1 to 4:1, and/or the total concentration of the carbon nanotubes and carbon black particles in the electrode composition can range from 0.5 to 3 wt % relative to the total weight of the electrode composition. The ratio of the carbon nanotubes to carbon black particles can have or include, for example, one of the following ranges: from 0.25:1 to 3.5:1, or from 0.25:1 to 3:1, or from 0.25:1 to 2.5:1, or from 0.25:1 to 2:1, or from 0.25:1 to 1.5:1, or from 0.25:1 to 1:1, or from 0.5:1 to 4:1, or from 0.5:1 to 3.5:1, or from 0.5:1 to 3:1, or from 0.5:1 to 2.5:1, or from 0.5:1 to 2:1, or from 0.5:1 to 1.5:1, or from 1:1 to 4:1, or from 1:1 to 4:1, or from 1:1 to 3.5:1, or from 1:1 to 3:1, or from 1:1 to 2.5:1, or from 1:1 to 2:1, or from 1.5:1 to 4:1, or from 1.5:1 to 3.5:1, or from 1.5:1 to 3:1, or from 1.5:1 to 2.5:1, or from 2:1 to 4:1, or from 2:1 to 3.5:1, or from 2:1 to 3:1, or from 2.5:1 to 4:1, or from 2.5:1 to 3.5:1, or from 3:1 to 4:1. The total concentration of the carbon nanotubes and carbon black particles in the electrode composition can have or include, for example, one of the following ranges: from 0.5 to 2.5 wt %, or from 0.5 to 2 wt %, or from 0.5 to 1.5 wt %, or from 0.5 to 1 wt %, or from 1 to 3 wt %, or from 1 to 2.5 wt %, or from 1 to 2 wt %, or from 1 to 1.5 wt %, or from 1.5 to 3 wt %, or from 1.5 to 2.5 wt %, or from 1.5 to 2 wt %, or from 2 to 3 wt %, or from 2 to 2.5 wt %, or from 2.5 to 3 wt %. In certain embodiments, each of the carbon nanotubes and carbon black particles in the electrode composition can be present independently in the range of 0.25 to 1 wt % relative to the total weight of the electrode composition. Each concentration of the carbon nanotubes and carbon black particles in the electrode composition can independently have or include, for example, one of the following ranges: from 0.25 to 0.75 wt %, or from 0.5 to 1 wt %. Other ranges within these ranges are possible.

For electrode compositions containing carbon black particles and graphenes described herein, the ratio of the carbon black particles to the graphenes can range from 0.25:1 to 4:1, and/or the total concentration of the carbon black particles and the graphenes in the electrode composition can range from 0.1 to 3 wt % relative to the total weight of the electrode composition. The ratio of the carbon black particles to the graphenes can have or include, for example, one of the following ranges: from 0.25:1 to 3.5:1, or from 0.25:1 to 3:1, or from 0.25:1 to 2.5:1, or from 0.25:1 to 2:1, or from 0.25:1 to 1.5:1, or from 0.25:1 to 1:1, or from 0.5:1 to 4:1, or from 0.5:1 to 3.5:1, or from 0.5:1 to 3:1, or from 0.5:1 to 2.5:1, or from 0.5:1 to 2:1, or from 0.5:1 to 1.5:1, or from 1:1 to 4:1, or from 1:1 to 4:1, or from 1:1 to 3.5:1, or from 1:1 to 3:1, or from 1:1 to 2.5:1, or from 1:1 to 2:1, or from 1.5:1 to 4:1, or from 1.5:1 to 3.5:1, or from 1.5:1 to 3:1, or from 1.5:1 to 2.5:1, or from 2:1 to 4:1, or from 2:1 to 3.5:1, or from 2:1 to 3:1, or from 2.5:1 to 4:1, or from 2.5:1 to 3.5:1, or from 3:1 to 4:1. The total concentration of the carbon black particles and the graphenes in the electrode composition can have or include, for example, one of the following ranges: from 0.1 to 2.5 wt %, or from 0.1 to 2 wt %, or from 0.1 to 1.5 wt %, or from 0.1 to 1 wt %, or from 0.1 to 0.5 wt %, or from 0.5 to 3 wt %, or from 0.5 to 2.5 wt %, or from 0.5 to 2 wt %, or from 0.5 to 1.5 wt %, or from 0.5 to 1 wt %, or from 1 to 3 wt %, or from 1 to 2.5 wt %, or from 1 to 2 wt %, or from 1 to 1.5 wt %, or from 1.5 to 3 wt %, or from 1.5 to 2.5 wt %, or from 1.5 to 2 wt %, or from 2 to 3 wt %, or from 2 to 2.5 wt %, or from 2.5 to 3 wt %. Each of the carbon black particles and graphenes in the electrode composition can be present independently in the range of 0.1 to 2.25 wt % relative to the total weight of the electrode composition. Each concentration of the carbon black particles and the graphenes in the electrode composition can independently have or include, for example, one of the following ranges: from 0.1 to 1.75 wt %, or from 0.1 to 1.25 wt %, or from 0.1 to 0.75 wt %, or from 0.5 to 2.25 wt %, or from 0.5 to 1.75 wt %, or from 0.5 to 1.25 wt %, or from 1 to 2.25 wt % or from 1 to 1.75 wt %, or from 1.5 to 2.25 wt %. Other ranges within these ranges are possible. In certain embodiments, these electrode compositions are substantially free of added carbon nanotubes.

In certain embodiments, the electrode composition further includes one or more binders to enhance the mechanical properties of the formed electrode. Exemplary binder materials include, but are not limited to, fluorinated polymers such as poly(vinyldifluoroethylene) (PVDF), poly(vinyldifluoroethylene-co-hexafluoropropylene) (PVDF-HFP), poly(tetrafluoroethylene) (PTFE), polyimides, and water-soluble binders, such as poly(ethylene) oxide, polyvinyl-alcohol (PVA), cellulose, carboxymethylcellulose (CMC), starch, hydroxypropylcellulose, regenerated cellulose, polyvinyl pyrrolidone (PVP), and copolymers and mixtures thereof. Other possible binders include polyethylene, polypropylene, ethylene-propylene-diene terpolymer (EPDM), sulfonated EPDM, styrene-butadiene rubber (SBR), and fluoro rubber and copolymers and mixtures thereof. In some embodiments, the binder is present in the cathode composition in an amount of 1 to 10% by weight.

An electrode (e.g., cathode) composition can be made by homogeneously interspersing (e.g., by uniformly mixing) the compositions described herein with the lithium metal phosphate. In some embodiments, the binder is also homogeneously interspersed with the compositions described herein and lithium metal phosphate. The electrode composition can take the form of a paste or a slurry, in which particulate lithium metal phosphate, conductive additives, dispersant(s) (if present), other additive(s) (if present), solvent, and binder (if present) are combined. The constituents of the electrode composition can be combined in any order so long as the resulting mixture is substantially homogeneous, which can be achieved by shaking, stirring, etc. In certain embodiments, the electrode composition is a solid resulting from solvent removal from the paste or slurry.

In some embodiments, an electrode is formed by depositing the paste onto an electrically conducting substrate (e.g., an aluminum current collector), followed by removing the solvent. In certain embodiments, the paste has a sufficiently high solids loading (i.e., high concentration of solids) to enable deposition onto the substrate while minimizing the formation of inherent defects (e.g., cracking) that may result with a less viscous paste (e.g., having a lower solids loading). Moreover, a higher solids loading reduces the amount of solvent needed. The solvent is removed by drying the paste, either at ambient temperature or under low heat conditions, e.g., temperatures ranging from 20° to 100° C. The deposited electrode/current collector can be cut to the desired dimensions, optionally followed by calendering.

The formed electrode can be incorporated into a lithium-ion battery according to methods known in the art, for example, as described in “Lithium Ion Batteries Fundamentals and Applications”, by Yuping Wu, CRC press, (2015).

In other embodiments, the compositions described herein are used (e.g., incorporated) in electrodes of other energy storage devices, such as, primary alkaline batteries, primary lithium batteries, nickel metal hydride batteries, sodium batteries, lithium sulfur batteries, lithium air batteries, and supercapacitors. Methods of making such devices are known in the art and are described, for example, in “Battery Reference Book”, by T R Crompton, Newness (2000).

### EXAMPLES

### Example 1

Lithium iron phosphate (LFP) electrodes were made following a two-step mixing process with a Thinky ARE310 planetary centrifugal mixer. The first step includes a 20-minute mixing (twelve minutes of active mixing) of a carbon conductive additive (CCA)/PVDF/NMP millbase with two small milling tungsten carbide (WC) media. After adding LFP powder (P2 grade from Phostech) into the millbase, the second step includes mixing for 20 more minutes (twelve minutes of active mixing) without media. Both LFP and CCA powders were pre-dried at 130° C. for 20 minutes.

CCA dispersion formulations are listed in Table I, where “CB” means carbon black, and “CNTs” means carbon nanotubes. In all electrodes, the binder was 2 wt. % PVDF (Arkema HSV900), and the total slurry solids contents was 56 wt. %. The physical properties of CCAs are listed in Table II.

TABLE I

| Cathode | CCA1 | CCA2 | Blend type |
|---|---|---|---|
| Control | N/A | N/A | N/A |
| Dispersion A | 1% LITX ® 300G | 1% Cnano | Graphene + |
| | | | CNTs |
| Dispersion B | 1% FCX ™ 80 | 1% ABG 1010 | CB + Graphite |
| Dispersion C | 1% LITX ® 300 | 1% Cnano | CB + CNTs |
| Dispersion D | 1% LITX ® 300 | 1% LITX ® 300G | CB + Graphene |
| 3% CNTs | 3% Cnano | N/A | CNTs only |

TABLE II

| | BET | | OAN, | | # | Lₐ | (I_{G}/(I_{G} + I_{D})) | L_{c} |
|---|---|---|---|---|---|---|---|---|
| | SA, | STSA, | mL/100 | SEP, | graphitic | Raman | % Cr | XRD, |
| Sample | m²/g | m²/g | g | mJ/m² | layers | Å | Raman | Å |
| LITX ® 300G | 300 | N/A | 115 | 24 | 324 | 31 | 42 | 1088 |
| FCX ™ 80 | 77 | 77 | 167 | ~0 | N/A | 67 | 61 | 59.6 |
| LITX ® 300 | 169 | 144 | 155 | 7 | N/A | 24 | 38 | 18.8 |
| ABG1010 | 19.7 | 24.2 | 130 | 35.3 | 34 | 176 | N/A | N/A |
| CNTs | 230 | N/A | N/A | N/A | 13 | 52.5 | 54.7 | 45.3 |

The electrode slurries were coated on carbon-primed aluminum foils (MTI Corporation, Cat. # EQ-CC-Al-18u-260) and Mylar® foils using an automated doctor blade coater (Model MSK-AFA-III from MTI Corp.). The NMP was evaporated for 20 minutes in a convection oven set at 80° C., and finally dried in a vacuum oven at ˜100° C. The dry electrode loadings were 10 mg/cm² on Al foils and 14 mg/cm² on Mylar® foils, calendered to a density of 2.3 g/cc with a manual roll press.

Sheet resistance of coated electrodes was measured with a Signatone Pro4-4400 commercial system (SP4 probe head connected to the rear of a Keithley 2410-C source meter). Measurements were performed in a four-wire configuration mode on the Mylar® coated electrodes to eliminate conductivity contribution of the substrate. The reported values are direct ohm readings from the instrument, at a current of 0.1 mA, and a cathode calendered density of 2.3 g/cc. Results show that CCA dispersions A, B and C and D significantly reduce electrode sheet resistance over control, to levels that are close to 3% CNTs.

### Example 2

The cathodes of Example 1 were tested in 2032 half coin cells. Fifteen-millimeter-in-diameter discs were punched for coin-cell preparation and dried at 110° C. under vacuum for a minimum of 4 hours. Discs were calendered at 2.3 g/cc with a manual roll press, and assembled into 2032 coin-cells in an argon-filled glove box (M-Braun) for testing against lithium foil. Glass fiber micro filters (Whatman GF/A) were used as separators. The electrolyte was 100 microliters of ethylene carbonate-dimethyl carbonate-ethylmethyl carbonate (EC-DMC-EMC), vinylene carbonate (VC) 1%, LiPF₆ 1 M (BASF). Four coin-cells were assembled for each formulation tested.

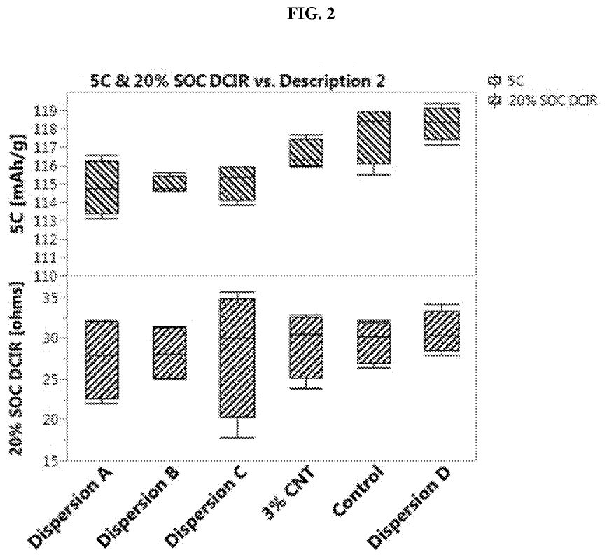

Reported capacities are averages of the four coin-cells, normalized in mAh/g of active cathode mass. Room temperature (20° C.) performance of the half coin-cells was measured by first forming them using two C/5-D/5 charge-discharge cycles, then charging them at 1C rate and discharging them at C/5, 1C, 2C, 5C, 10C, 12C, 15C and 20C discharge rates. Then their Hybrid Pulse Power Capability (HPPC) was tested using 3.75C charge and 5C discharge pulses of 10 s every 10% states of charge from fully charged to fully discharged. All additives provide performance similar to control at room temperature, both in terms of 5C capacity (full discharge in 12 minutes) or internal resistance (DC-IR) at 20% state of charge, measured on the 10 s 5C HPPC current pulses (FIG. 2).

### Example 3

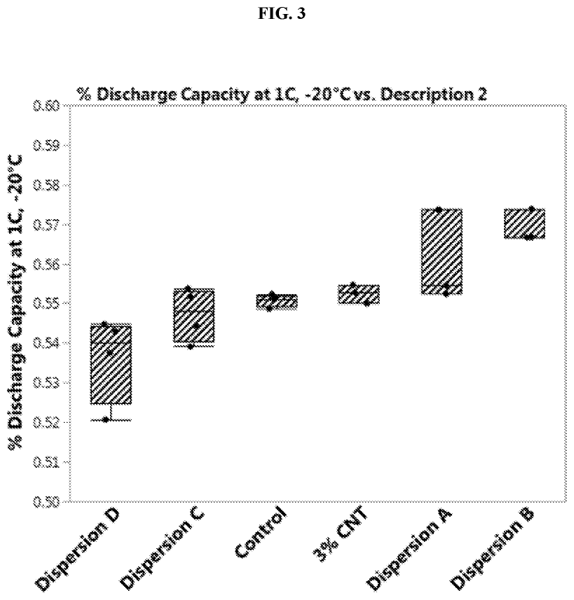

Low temperature performance of the half coin-cells was measured by charging them at +20° C. using 1C charging rate and discharging them at −20° C., using 1C discharge rate. The capacity retention at −20° C. was calculated relative to the 1C discharge capacity at +20° C. Dispersions A and C had performance similar to Control and CNTs only. Dispersion B had performance superior to Control and CNTs only (FIG. 3).

### Example 4

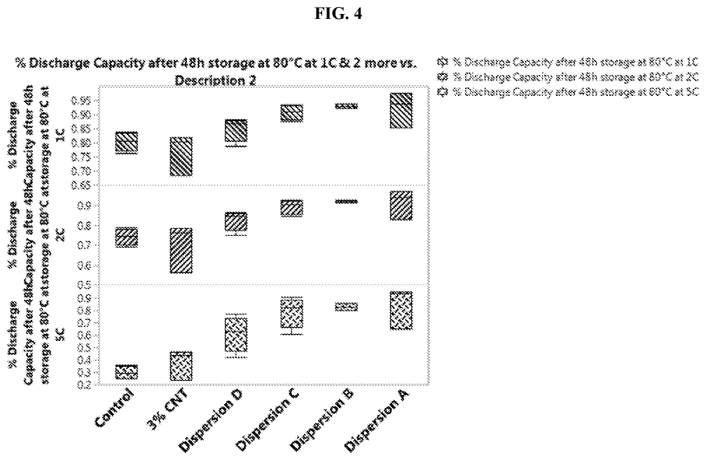

Fully charged half coin-cells were stored for 48 hours in an 85° C. thermally controlled environmental chamber, then brought back to room temperature and checked for capacity at 1C, 2C and 5C discharge rates. Capacity retention was calculated as the ratio of same discharge rate capacity before hot storage. All dispersions had superior capacity retention after exposure to elevated temperature. Performance remained better even at 5C discharge rate. 3% CNTs was no better than control (no CCA) in this test, suggesting the importance of CCA blends in electrode formulation (FIG. 4).

### Example 5

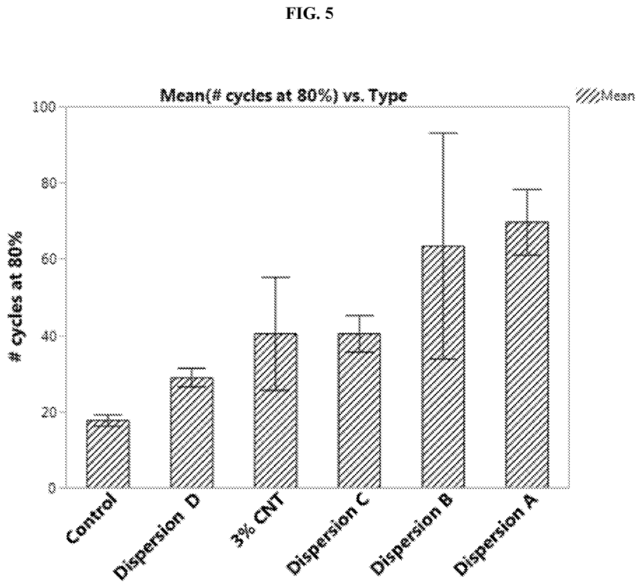

Cycle life was measured on full coin-cells using graphite anodes at 1C (1 h) charge and discharge rates, in a 60° C. thermally controlled environmental chamber. Cycle life was determined as the number of cycles completed until 80% of initial capacity was retained. Dispersions A and B both had improved cycle-life over 3% CNTs, at reduced 2% total CCA. Dispersion C had cycle life similar to 3% CNTs (FIG. 5). From a cost perspective, Dispersion B is beneficial over Dispersions A, C, and CNTs only because it does not contain CNTs. Dispersion B had the best combination of properties resulting in overall best performance and lowest cost due to the lack of use of expensive CNTs.

The use of the terms “a” and “an” and “the” is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

All publications, applications, ASTM standards, and patents referred to herein are incorporated by reference in their entirety.

Still other embodiments of the present invention will be apparent to those skilled in the art from consideration of the present specification and practice of the present invention disclosed herein. It is intended that the present specification and examples be considered as exemplary only with a true scope and spirit of the invention being indicated by the following claims and equivalents thereof.

What is claimed is:

1. A composition, comprising:
carbon black particles having a surface energy less than 5 mJ/m²;
graphite particles having a BET surface area greater than 5 m²/g and more than about 50 graphitic layers, wherein the ratio of the carbon black particles to the graphite particles ranges from 0.25:1 to 4:1 by weight; and
a liquid medium.

2. The composition of claim 1, comprising a total of from 0.1 to 5 wt % of the carbon black particles and the graphite particles.

3. (canceled)

4. (canceled)

5. The composition of claim 1, wherein the carbon black particles have one, two, three, four, five, six, seven or eight of the following properties, in any combination:
(a) an Lₐ crystallite size, as determined by Raman spectroscopy, ranging from 50 Å to 100 Å;
(b) an L_{c} crystallite size, as determined by X-ray diffraction, ranging from 50 Å to 100 Å;
(c) a % crystallinity ((I_{G}/(I_{G}+I_{D}))×100%), as determined by Raman spectroscopy, ranging from 35% to 70%;
(d) a BET surface area ranging from 50 to 250 m²/g;
(e) an STSA ranging from 50 to 250 m²/g;
(f) an OAN ranging from 100 to 300 mL/100 g;
(g) an aggregate size distribution, as indicated by D₅₀ values of particle size distributions, ranging from 20 to 400 nm; and/or
(h) oxygen content from 0 to 0.1 wt %.

6. (canceled)

7. (canceled)

8. The composition of claim 1, wherein the graphite particles have one or both of the following properties:
(a) a diameter, as determined by laser scattering, ranging from 5 to 25 micrometers; and/or
(b) a % crystallinity, ((I_{G}/(I_{G}+I_{D}))×100%), as determined by Raman spectroscopy, ranging from 90 to 100%.

9. The composition of claim 1, wherein the liquid medium is selected from the group consisting of N-methylpyrrolidone (NMP), acetone, an alcohol, and water.

10. The composition of claim 1, further comprising a dispersant.

11. An electrode, comprising:
an electrode composition comprising
carbon black particles having a surface energy less than 5 mJ/m²;
graphite particles having a BET surface area greater than 5 m²/g and more than about 50 graphitic layers, and
lithium metal phosphate,
wherein the total concentration of the carbon black particles and the graphite particles is equal to or less than 3 wt % of the electrode composition; and
a current collector contacting the electrode composition.

12. The electrode of claim 11, wherein the total concentration of the carbon black particles and the graphite particles ranges from 0.5 to 3 wt % of the electrode composition.

13. (canceled)

14. (canceled)

15. The electrode of claim 11, wherein the ratio of the carbon black particles to the graphite particles ranges from 0.25:1 to 4:1 by weight.

16-24. (canceled)

25. A method comprising: using the composition of claim 1 to make an electrode or a battery.

26. The method of claim 25, comprising combining lithium metal phosphate with the composition of claim 1.

27-79. (canceled)

80. A composition, comprising:
carbon black particles having a surface energy less than 5 mJ/m²;
graphenes, wherein the ratio of the carbon black particles to the graphenes ranges from 0.25:1 to 4:1 by weight; and
a liquid medium.

81-83. (canceled)

84. The composition of claim 80, wherein the carbon black particles have one, two, three, four, five, six, seven or eight of the following properties, in any combination:
(a) an Lₐ crystallite size, as determined by Raman spectroscopy, ranging from 50 Å to 100 Å;
(b) an L_{c} crystallite size, as determined by X-ray diffraction, ranging from 50 Å to 100 Å;
(c) a % crystallinity ((I_{G}/(I_{G}+I_{D}))×100%), as determined by Raman spectroscopy, ranging from 35% to 70%;
(d) a BET surface area ranging from 50 to 250 m²/g;
(e) an STSA ranging from 50 to 250 m²/g;
an OAN ranging from 100 to 300 mL/100 g;
(g) an aggregate size distribution, as indicated by D₅₀ values of particle size distributions, ranging from 20 to 400 nm; and/or
(h) oxygen content from 0 to 0.1 wt %.

85. (canceled)

86. (canceled)

87. The composition of claim 80, wherein the graphenes have one or both of the following properties:
(a) a BET surface area ranging from 100 to 500 m²/g; and/or
(b) from about 20 to about 50 graphitic layers.

88. The composition of claim 80, wherein the liquid medium is selected from the group consisting of N-methylpyrrolidone (NMP), acetone, an alcohol, and water.

89. (canceled)

90. An electrode, comprising:
an electrode composition comprising
carbon black particles having a surface energy less than 5 mJ/m²;
graphenes, and
lithium metal phosphate,
wherein the total concentration of the carbon black particles and the graphenes is equal to or less than 3 wt % of the electrode composition; and
a current collector contacting the electrode composition.

91-103. (canceled)

104. A method comprising: using the composition of claim 80 to make an electrode or a battery.

105. The method of claim 104, comprising combining lithium metal phosphate with the composition of claim 80.

106. (canceled)
